(19) United States
(12) Patent Application Publication
(10) Pub. No.: US 2019/0232185 A1
(43) Pub. Date: Aug. 1, 2019

(54) ELECTRICAL BUILDING BLOCK

(71) Applicant: EAGLE Technology Co., Ltd., New Taipei City (TW)

(72) Inventors: WEI-CHEN LIN, New Taipei City (TW); CHUNG-I LEE, New Taipei City (TW); CHIEN-YING YANG, New Taipei City (TW)

(21) Appl. No.: 16/260,206

(22) Filed: Jan. 29, 2019

Related U.S. Application Data
(60) Provisional application No. 62/623,053, filed on Jan. 29, 2018.

(51) Int. Cl. A63H 33/08; A63H 33/04; H01R 13/514

(52) U.S. Cl. CPC A63H 33/086; H01R 13/514; A63H 33/042

(57) ABSTRACT

An electrical building block includes docking structures, a first electrical connection mechanism, a second electrical connection mechanism and a circuit board. The docking structures are located at a top side of the electrical building block. The first electrical connection mechanism and the second electrical connection mechanism are electrically connected with the circuit board and disposed within the electrical building block. The first electrical connection mechanism is penetrated through the top side and elastically protruded out of the docking structures. The second electrical connection mechanism is located at a bottom side of the electrical building block. The second electrical connection mechanism of the electrical building block is docked with the first electrical connection mechanism of an adjacent electrical building block. Moreover, the two electrical connection mechanisms are formed on at least one lateral side of the electrical building block to be connected with another adjacent electrical building block.

### CROSS-REFERENCE TO RELATED APPLICATION

This application claims priority to U.S. Provisional Patent Application No. 62/623,053 filed Jan. 29, 2018, the contents of which are incorporated herein by reference.

### FIELD OF THE INVENTION

The present invention relates to an electrical building block, and more particularly to an electrical building block with two types of electrical connection mechanisms on at least one lateral side, so that plural electrical building blocks can be electrically connected with each other in diverse directions.

### BACKGROUND OF THE INVENTION

In the early stage, the building block is one kind of plastic toy. Each building block can be closely engaged with another building block, and plural building blocks are assembled into a specified shape, for example a car or a house. Consequently, the uses of the building blocks can facilitate the growth of the child's brain and stimulate the imagination space of the child.

Due to the increasingly fine design, rich colors and versatile variety of building blocks, special products have been developed. Consequently, electrical building blocks with functional components are introduced into the market. For example, through the electrical building block with a motor, the assembled car can be moved. Alternatively, through the electrical building block with a LED, the assembled house can emit a light beam. Due to the electrical building blocks with functional components, the efficacy of enjoying the learning process by the child is enhanced, and the versatile efficacy and the interesting efficacy are increased.

In the commercially available electrical building block, two electrical connection mechanisms are located at two opposite lateral sides. For example, the two electrical connection mechanism are only located at the top side and the bottom side of the electrical building block, or only located at the front side and the rear side (or the left side and the right side) of the electrical building block. Consequently, plural adjacent electrical building blocks are electrically connected with each other through the unidirectional connection. Moreover, for transferring electric signals between these electrical building blocks, each electrical connection mechanism has to be docked with the adjacent electrical connection mechanism through a specified docking method, an additional docking tool or a specified orientation. That is, the assembling process of the commercially available building blocks is limited by the locations and the direction of the electrical connection mechanism. For example, the electrical building blocks are connected with each other along a horizontal direction (i.e., a forward/backward direction), or the electrical building blocks are electrically connected with each other along a vertical direction (i.e., an upward/downward direction). In other words, this design is detrimental to the overall space utilization and the style flexibility.

In case that the assembling requirements of the overall electrical building block product are taken into consideration, plural electrical building blocks of the same type are required because the assembling process of the commercially available building blocks is limited by the locations and the directions of the electrical connection mechanism. Consequently, the cost of using the building blocks is largely increased.

Moreover, the conventional building blocks still have some other drawbacks. For accommodating more function modules, the type, shape or number of the docking structures that are formed on the surface of the electrical building block to be assembled with other building blocks need to be sacrificed. That is, the docking flexibility of the electrical building block is restricted. Moreover, since the number of the function modules is increased and the design is unsatisfactory, many components are exposed outside. Under this circumstance, the conventional electrical building blocks are not aesthetically pleasing and the danger of using the electrical building blocks is increased.

For overcoming the drawbacks of the conventional technologies, there is a need of providing a novel and user-friendly electrical building block to increase the variety and variability of the finished product without reducing the assembling flexibility.

### SUMMARY OF THE INVENTION

An object of the present invention provides an electrical building block. The electrical building block retains the docking structures to be assembled with the general building blocks. In addition, the applications of the electrical connection mechanisms with different docking specifications are improved. The electrical building block includes a first electrical connection mechanism and a second electrical connection mechanism. The first electrical connection mechanism and the second electrical connection mechanism are located at the docking structures and arranged on any side of the electrical building block. Consequently, the electrical building block can be electrically connected with any lateral side of an adjacent electrical building block along diverse directions. Alternatively, plural electrical building blocks can be electrically connected with each other in a multiple-to-multiple arrangement.

In accordance with an aspect of the present invention, an electrical building block is provided. The electrical building block includes a block body and an electrical function module. The block body includes a top side, a bottom side, plural top-side docking structures, plural bottom-side docking structures, and plural lateral sides between the top side and the bottom side. One of the top side and the bottom side is provided with a first electrical connection mechanism. The other of the top side and the bottom side is provided with a second electrical connection mechanism. At least one of the plural lateral sides is provided with the first electrical connection mechanism and the second electrical connection mechanism. The electrical function module is combined with the block body. The electrical function module is electrically connected with at least one of the first electrical connection mechanism and the second electrical connection mechanism. The electrical function module performs an electrical function operation.

In an embodiment, the electrical building block further includes a circuit board. The circuit board is electrically connected with the first electrical connection mechanism, the second electrical connection mechanism and the electrical function module.

In an embodiment, the electrical building block further includes an electrical connection board. A first end of at least one electrical contact structure of the first electrical connection mechanism is connected with the electrical connection board and electrically connected with the circuit board through the electrical connection board. A second end of the at least one electrical contact structure of the first electrical connection mechanism is protruded out of the top side. Moreover, at least one electrical contact structure of the second electrical connection mechanism is electrically contacted with the circuit board and exposed to the bottom side.

In an embodiment, at least one electrical contact structure of the first electrical connection mechanism is disposed within at least one corresponding top-side docking structure, or at least one electrical contact structure of the second electrical connection mechanism is disposed within at least one corresponding bottom-side docking structure.

In an embodiment, the at least one electrical contact structure of the first electrical connection mechanism is received within or exposed to a first opening in the at least one corresponding top-side docking structure. Moreover, the at least one electrical contact structure of the second electrical connection mechanism is exposed to or received within a second opening in the at least one corresponding bottom-side docking structure.

In an embodiment, at least one electrical contact structure of the first electrical connection mechanism and at least one electrical contact structure of the second electrical connection mechanism corresponding to the at least one of the plural lateral sides are horizontally arranged side by side. Moreover, the at least one electrical contact structure of the first electrical connection mechanism and the at least one electrical contact structure of the second electrical connection mechanism are received within or exposed to plural third openings in the at least one of the plural lateral sides.

In an embodiment, at least one electrical contact structure of the first electrical connection mechanism and at least one electrical contact structure of the second electrical connection mechanism are complementary to each other. If the electrical contact structure of the first electrical connection mechanism is a male connector selected from a plug or a pin, the electrical contact structure of the second electrical connection mechanism is a female connectors selected from a receptacle or a pad. Whereas, if the electrical contact structure of the first electrical connection mechanism is the female connector, the electrical contact structure of the second electrical connection mechanism is the male connector.

In an embodiment, the plural top-side docking structures are located at the top side, the plural bottom-side docking structures are located at the bottom side, and the plural top-side docking structures and plural bottom-side docking structures are complementary. The plural top-side docking structures are in an array arrangement, and the plural bottom-side docking structures are in another array arrangement. The top-side docking structures are protrusion posts and the bottom-side docking structures are concave structures, or the top-side docking structures are concave structures and the bottom-side docking structures are protrusion posts.

In an embodiment, the top side, the plural top-side docking structures and the plural lateral side are integrally formed as a one-piece structure, and the one-piece structure and the bottom side with the bottom-side docking structures are collaboratively formed as the block body. The upper edges of the plural lateral sides are connected with the periphery of the top side. The lower edges of the plural lateral sides are connected with a periphery of the bottom side.

In an embodiment, if a specified electrical contact structure of the first electrical connection mechanism and the second electrical connection mechanism has a first polarity, two electrical contact structures horizontally arranged at two opposite sides of the specified electrical contact structure have the first polarity and a second polarity, respectively. Whereas, if the specified electrical contact structure of the first electrical connection mechanism and the second electrical connection mechanism has the second polarity, the electrical contact structure horizontally arranged beside a first side of the specified electrical contact structure has the first polarity.

In an embodiment, if the specified electrical contact structure of the first electrical connection mechanism and the second electrical connection mechanism has the second polarity, the electrical contact structure vertically arranged beside a first side of the specified electrical contact structure has the first polarity. Whereas, if the specified electrical contact structure of the first electrical connection mechanism and the second electrical connection mechanism has the second polarity, the electrical contact structure horizontally arranged beside a second side of the specified electrical contact structure has the first polarity. If the first polarity is an output voltage or a positive polarity (+), the second polarity is a ground voltage or a negative polarity (−). Whereas, if the second polarity is the output voltage or the positive polarity (+), the second polarity is the ground voltage or the negative polarity (−).

In an embodiment, if a specified electrical contact structure of the first electrical connection mechanism and the second electrical connection mechanism has a first polarity, two electrical contact structures horizontally arranged at two opposite sides of the specified electrical contact structure have a second polarity. Whereas, if the specified electrical contact structure of the first electrical connection mechanism and the second electrical connection mechanism has the second polarity, the two electrical contact structures horizontally arranged at the two opposite sides of the specified electrical contact structure have the first polarity. If the first polarity is an output voltage or a positive polarity (+), the second polarity is a ground voltage or a negative polarity (−). Whereas, if the second polarity is the output voltage or the positive polarity (+), the second polarity is the ground voltage or the negative polarity (−).

In an embodiment, the polarities of four consecutive electrical contact structures of at least one of the first electrical connection mechanism and the second electrical connection mechanism along a horizontal direction or a vertical direction are sequentially positive (+), negative (−), negative (−) and positive (+), or sequentially negative (−), positive (+), positive (+) and negative (−), or sequentially positive (+), negative (−), positive (+) and negative (−), or sequentially negative (−), positive (+), negative (−) and positive (+).

In an embodiment, electrical contact structures of the first electrical connection mechanism and/or the second electrical connection mechanism having a first polarity are serially connected with each other to define a first electric loop, and electrical contact structures of the first electrical connection mechanism and/or the second electrical connection mechanism having a second polarity are serially connected with each other to define a second electric loop.

In an embodiment, the electrical function module includes at least one of a power module, a control module and a motion module. If the electrical function module is the power module, the first electrical connection mechanism, the second electrical connection mechanism and the power module are assembled as a power-type building block. If the electrical function module is the control module, the first electrical connection mechanism, the second electrical connection mechanism and the control module are assembled as a control-type building block. If the electrical function module is the motion module, the electrical building block with the first electrical connection mechanism, the second electrical connection mechanism and the motion module are assembled as a motion-type building block.

In an embodiment, the power-type building block is a power-storage building block. A power-storage battery module is accommodated within an inner space of the power-type building block to output electricity through one of the first electrical connection mechanism and the second electrical connection mechanism.

In an embodiment, the control-type building block includes at least one of a button switch building block, a tactile switch building block, a toggle switch building block, a slide switch building block, an adjustable (variable) resistor building block, a sensor building block, a wireless transceiver building block, an editable control program building block, a polarity-switchable building block and a boost control building block. The motion-type building block comprises at least one of an illumination building block, a driving building block and a warning building block.

In an embodiment, the electrical building block further includes at least one magnet or at least one magnetic buckle, which are disposed on the plural lateral sides and arranged near the first electrical connection mechanism and/or the second electrical connection mechanism to enhance docking stability.

In accordance with another aspect of the present invention, an electrical building block is provided. The electrical building block includes a block body, a first electrical connection mechanism, a second electrical connection mechanism and an electrical function module. The block body includes a top side, a bottom side, plural top-side docking structures, plural bottom-side docking structures and plural lateral sides. The plural top-side docking structures are located at the top side. The plural bottom-side docking structures are located at the bottom side. The plural lateral sides are arranged between the top side and the bottom side. The first electrical connection mechanism is located at the plural lateral sides and at least one of the plural top-side docking structures. The second electrical connection mechanism is located at the plural lateral sides and at least one of the plural bottom-side docking structures. The electrical function module is combined with the block body. The electrical function module is electrically connected with at least one of the first electrical connection mechanism and the second electrical connection mechanism. The electrical function module performs an electrical function operation.

In an embodiment, the electrical building block further includes a circuit board. The circuit board is electrically connected with the first electrical connection mechanism, the second electrical connection mechanism and the electrical function module.

In an embodiment, the electrical building block further includes an electrical connection board. A first end of at least one electrical contact structure of the first electrical connection mechanism is connected with the electrical connection board and electrically connected with the circuit board through the electrical connection board. A second end of the at least one electrical contact structure of the first electrical connection mechanism is protruded out of the top side. Moreover, at least one electrical contact structure of the second electrical connection mechanism is electrically contacted with the circuit board and exposed to the bottom side.

In an embodiment, at least one electrical contact structure of the first electrical connection mechanism is received within or exposed to a first opening in the at least one corresponding top-side docking structure, and at least one electrical contact structure of the second electrical connection mechanism is exposed to or received within a second opening in the at least one corresponding bottom-side docking structure.

In an embodiment, at least one electrical contact structure of the first electrical connection mechanism and at least one electrical contact structure of the second electrical connection mechanism corresponding to the at least one of the plural lateral sides are horizontally arranged side by side. Moreover, the at least one electrical contact structure of the first electrical connection mechanism and the at least one electrical contact structure of the second electrical connection mechanism are received within or exposed to plural third openings in the at least one of the plural lateral sides.

In an embodiment, at least one electrical contact structure of the first electrical connection mechanism and at least one electrical contact structure of the second electrical connection mechanism are complementary to each other. If the electrical contact structure of the first electrical connection mechanism is a male connector selected from a plug or a pin, the electrical contact structure of the second electrical connection mechanism is a female connectors selected from a receptacle or a pad. Whereas, if the electrical contact structure of the first electrical connection mechanism is the female connector, the electrical contact structure of the second electrical connection mechanism is the male connector.

In an embodiment, electrical contact structures of the first electrical connection mechanism and/or the second electrical connection mechanism having a first polarity are serially connected with each other to define a first electric loop, and electrical contact structures of the first electrical connection mechanism and/or the second electrical connection mechanism having a second polarity are serially connected with each other to define a second electric loop.

In an embodiment, if the first polarity is an output voltage or a positive polarity (+), the second polarity is a ground voltage or a negative polarity (−). Whereas, if the second polarity is the output voltage or the positive polarity (+), the second polarity is the ground voltage or the negative polarity (−).

In accordance with another aspect of the present invention, an electrical building block is provided. The electrical building block includes a block body, an electrical function module and plural electrical contact structures. The block body includes plural top-side docking structures, and/or plural bottom-side docking structures, and plural lateral sides. The plural top-side docking structures are located at a top side of the block body. The plural bottom-side docking structures are located at a bottom side of the block body. The plural lateral sides are arranged between the top side and the bottom side. The electrical function module is combined with the block body. The plural electrical contact structures are located at the plural lateral sides, at least one of the plural top-side docking structures and/or at least one of the plural bottom-side docking structures. If a specified electrical contact structure of the plural electrical contact structures has a first polarity, the two electrical contact structures horizontally arranged at two opposite sides of the specified electrical contact structure have the first polarity and a second polarity, respectively. Whereas, if the specified electrical contact structure has the second polarity, the electrical contact structure horizontally arranged beside a first side of the specified electrical contact structure has the first polarity. If the specified electrical contact structure of the plural electrical contact structures has the first polarity, the two electrical contact structures horizontally arranged at two opposite sides of the specified electrical contact structure have the second polarity. Whereas, if the specified electrical contact structure has the second polarity, the two electrical contact structures horizontally arranged at the two opposite sides of the specified electrical contact structure have the first polarity.

In an embodiment, the electrical building block further includes a circuit board, wherein the circuit board is electrically connected with the plural electrical contact structure and the electrical function module.

In an embodiment, if the specified electrical contact structure has the second polarity, the electrical contact structure vertically arranged beside a first side of the specified electrical contact structure has the first polarity. Whereas, if the specified electrical contact structure has the second polarity, the electrical contact structure horizontally arranged beside a second side of the specified electrical contact structure has the first polarity.

In an embodiment, the electrical contact structures having a first polarity are serially connected with each other to define a first electric loop, and the electrical contact structures having a second polarity are serially connected with each other to define a second electric loop.

In an embodiment, if the first polarity is an output voltage or a positive polarity (+), the second polarity is a ground voltage or a negative polarity (−). Whereas, if the second polarity is the output voltage or the positive polarity (+), the second polarity is the ground voltage or the negative polarity (−).

In an embodiment, the plural electrical contact structures include at least one first electrical contact structure and at least one second electrical contact structure, which are complementary to each other. If the first electrical contact structure is a male connector selected from a plug or a pin, the second electrical contact structure is a female connectors selected from a receptacle or a pad. Whereas, if the first electrical contact structure is the female connector, the second electrical contact structure is the male connector.

In an embodiment, the at least one electrical contact structure is received within or exposed to a first opening in the at least one corresponding top-side docking structure. Moreover, the at least one second electrical contact structure is exposed to or received within a second opening in the at least one corresponding bottom-side docking structure.

In an embodiment, the at least one first electrical contact structure and the at least one second electrical contact structure corresponding to the at least one of the plural lateral sides are horizontally arranged side by side. Moreover, the at least one first electrical contact structure and the at least one second electrical contact structure are received within or exposed to plural third openings in the at least one of the plural lateral sides.

In an embodiment, the electrical function module is an extension cord, the block body is located at an end or two ends of the extension cord, and the electrical building block with the extension cord is a cord-type electrical building block. The electrical contact structures of the cord-type electrical building block comply with a single docking specification, or the electrical contact structures of the cord-type electrical building block comply with two different docking specifications.

In accordance with another aspect of the present invention, an electrical building block is provided. The electrical building block includes a block body, plural electrical contact structures and an electrical function module. The block body includes plural top-side docking structures, and/or plural bottom-side docking structures, and plural lateral sides. The plural top-side docking structures are located at a top side of the block body. The plural bottom-side docking structures are located at a bottom side of the block body. The plural lateral sides are arranged between the top side and the bottom side. The plural electrical contact structures are located at the plural lateral sides, at least one of the plural top-side docking structures and/or at least one of the plural bottom-side docking structures. The polarities of every four consecutive electrical contact structures of the plural electrical contact structures along a horizontal direction or a vertical direction are sequentially positive (+), negative (−), negative (−) and positive (+), or sequentially negative (−), positive (+), positive (+) and negative (−), or sequentially positive (+), negative (−), positive (+) and negative (−), or sequentially negative (−), positive (+), negative (−) and positive (+). The electrical function module is combined with the block body.

In an embodiment, the electrical building block further includes a circuit board. The circuit board is electrically connected with the plural electrical contact structure and the electrical function module.

In an embodiment, the electrical contact structures having a first polarity are serially connected with each other to define a first electric loop, and the electrical contact structures having a second polarity are serially connected with each other to define a second electric loop.

In an embodiment, the plural electrical contact structures include at least one first electrical contact structure and at least one second electrical contact structure, which are complementary to each other. If the first electrical contact structure is a male connector selected from a plug or a pin, the second electrical contact structure is a female connectors selected from a receptacle or a pad. Whereas, if the first electrical contact structure is the female connector, the second electrical contact structure is the male connector.

In an embodiment, the at least one electrical contact structure is received within or exposed to a first opening in the at least one corresponding top-side docking structure. Moreover, the at least one second electrical contact structure is exposed to or received within a second opening in the at least one corresponding bottom-side docking structure.

In an embodiment, the at least one first electrical contact structure and the at least one second electrical contact structure corresponding to the at least one of the plural lateral sides are horizontally arranged side by side. Moreover, the at least one first electrical contact structure and the at least one second electrical contact structure are received within or exposed to plural third openings in the at least one of the plural lateral sides.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating the concepts according to a first embodiment of the present invention;

FIG. 1B is a schematic bottom view illustrating the concepts as shown in FIG. 1A according to the first embodiment of the present invention;

FIG. 1C is a schematic exploded view illustrating the concepts as shown in FIG. 1A according to the first embodiment of the present invention;

FIG. 1D is a schematic exploded view illustrating the concepts as shown in FIG. 1A according to the first embodiment of the present invention and taken along another viewpoint;

FIG. 1E schematically illustrates the circuitry as shown in FIG. 1A according to the first embodiment of the present invention;

FIG. 2A is a schematic perspective view illustrating the concepts according to a second embodiment of the present invention;

FIG. 2B is a schematic perspective view illustrating the concepts as shown in FIG. 2A and taken along another viewpoint;

FIG. 2C is a schematic perspective view illustrating the concepts according to a third embodiment of the present invention;

FIG. 3 is a schematic perspective view illustrating the concepts according to a fourth embodiment of the present invention;

FIG. 4 is a schematic perspective view illustrating the concepts according to a fifth embodiment of the present invention;

FIG. 5 is a schematic perspective view illustrating the concepts according to a sixth embodiment of the present invention;

FIG. 6A is schematic perspective view illustrating the concepts according to a seventh embodiment of the present invention;

FIG. 6B is a partial enlarged view illustrating the concepts as shown in FIG. 6A;

FIG. 7A is schematic perspective view illustrating the concepts according to an eighth embodiment of the present invention;

FIG. 7B is a partial enlarged view illustrating the concepts as shown in FIG. 7A;

FIG. 8 schematically illustrates a first method of assembling the electrical building blocks according to the concepts of the present invention;

FIG. 9 schematically illustrates a second method of assembling the electrical building blocks according to the concepts of the present invention;

FIG. 10 schematically illustrates a third method of assembling the electrical building blocks according to the concepts of the present invention;

FIG. 11 schematically illustrates a fourth method of assembling the electrical building blocks according to the concepts of the present invention; and

FIG. 12 schematically illustrates a fifth method of assembling the electrical building blocks according to the concepts of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

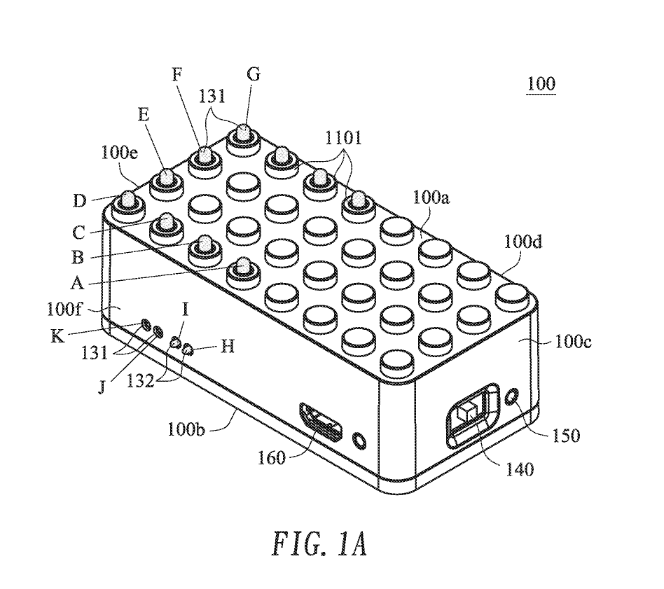

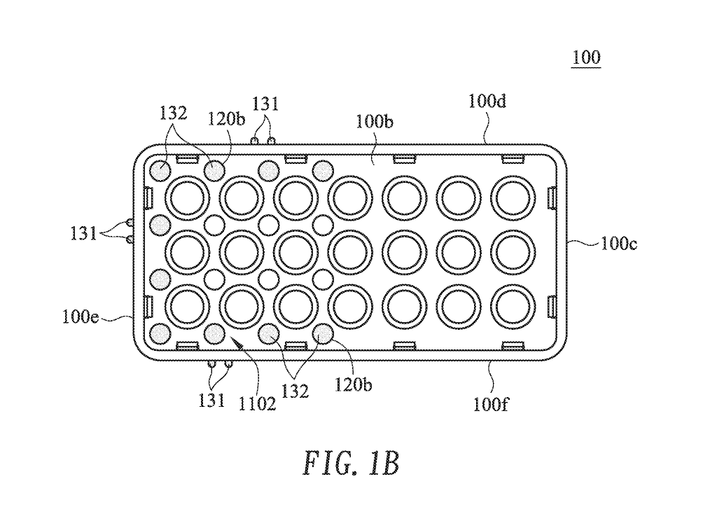

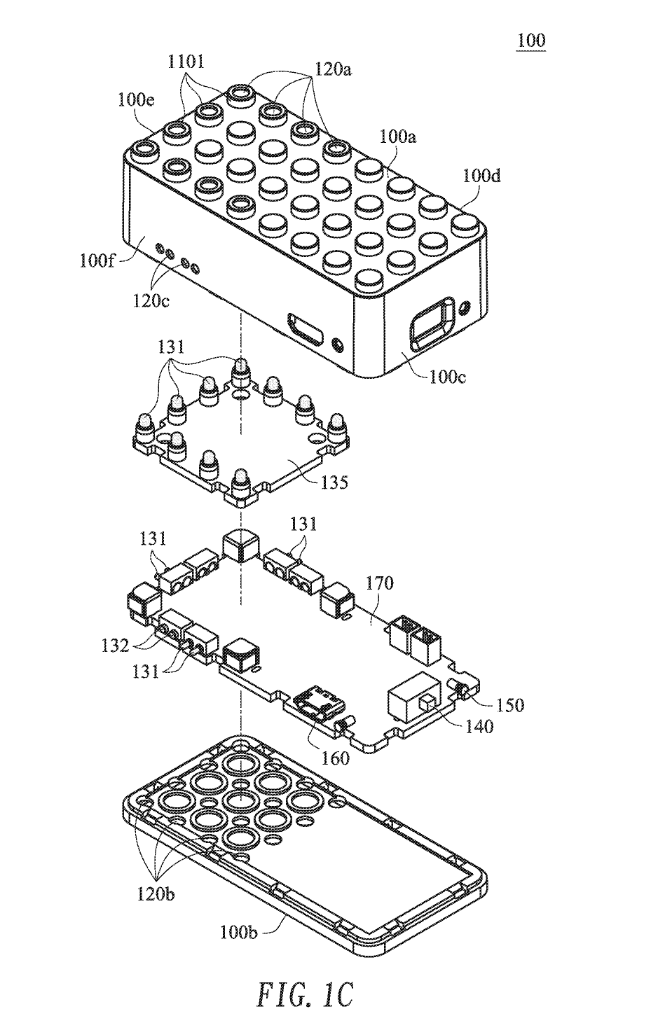

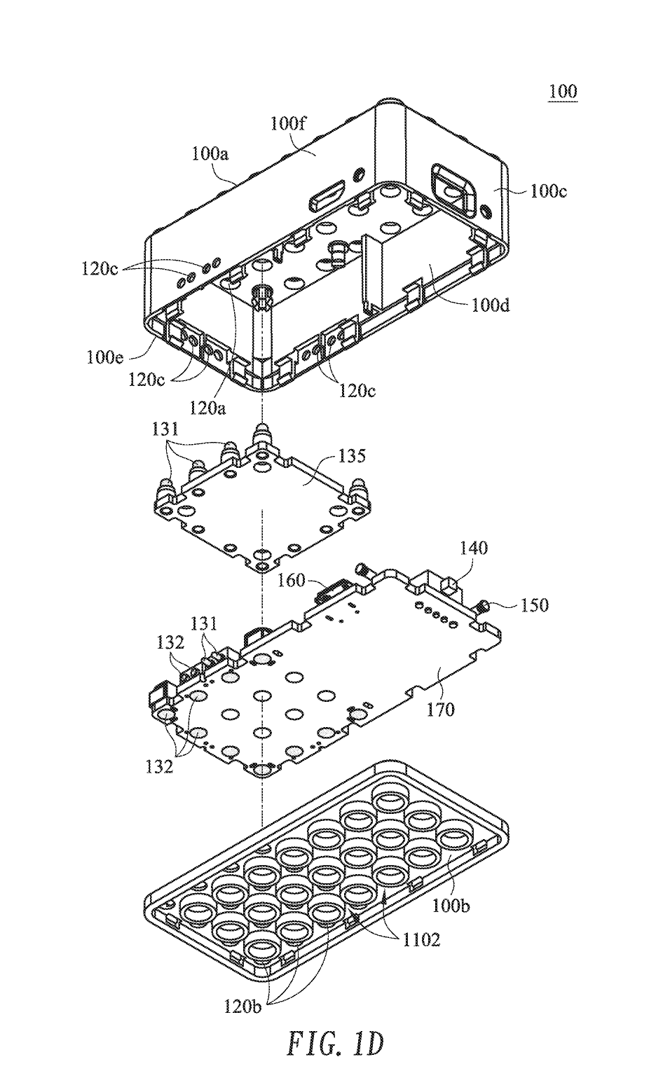

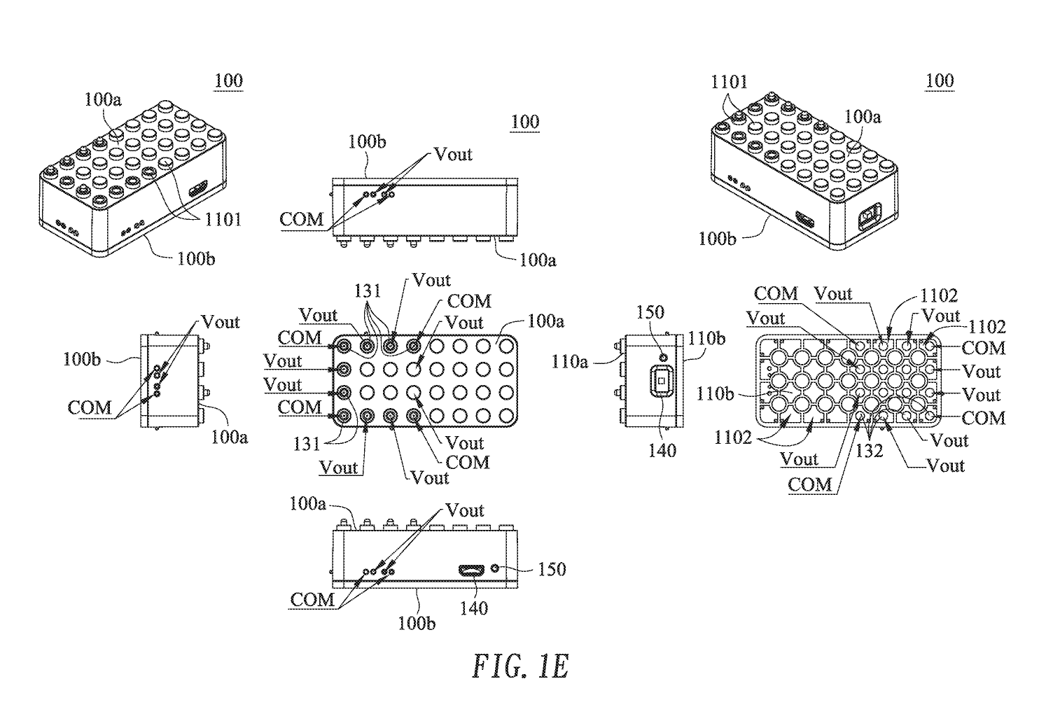

FIGS. 1A to 1E are schematic perspective view, bottom view and exploded view illustrating the concepts according to a first embodiment of the present invention.

The present invention provides an electrical building block. The electrical building block of the present invention also retains the docking structure to be assembled with the general building block such as a LEGO building block. For example, the commercially available LEGO building block usually has the size from 1×1 cm to 48×48 cm. According to the technology of the present invention, the electrical connection mechanisms for connecting plural electrical building blocks are improved. The electrical connection mechanisms include a first electrical connection mechanism and a second electrical connection mechanism. Hereinafter, the combination and application of the two electrical connection mechanisms with different docking specifications will be illustrated by taking a power-storage building block of the electrical building block as an example.

As shown in FIGS. 1A to 1E, an electrical building block 100 is provided. For example, the electrical building block 100 is a power-storage building block with a dimension of 31.8×63.8×19.9 mm, which is equivalent to the 4×8 size of the commercially available LEGO building block. The power-storage building block 100 comprises a top side 100a, a bottom side 100b, plural lateral sides 100c, 100d, 100e, 100f, plural top-side docking structures 1101, plural bottom-side docking structures 1102, plural first openings 120a, plural second openings 120b, plural third openings 120c, a first electrical connection mechanism with plural first electrical contact structures 131, a second electrical connection mechanism with plural second electrical contact structures 132, an electrical connection board 135, a switch element 140, an indication lamp 150, a connecting port 160 and a circuit board 170. For example, the plural first electrical contact structures 131 are male connectors such as plugs or pins, and the plural second electrical contact structures 132 are female connectors such as receptacles or pads. The circuit board 170 is electrically connected with the first electrical contact structures 131, the second electrical contact structures 132, the electrical connection board 135, the switch element 140, the indication lamp 150 and the connecting port 160.

Please refer to FIGS. 1A and 1B again. The top side 100a of the power-storage building block 100 comprises the plural top-side docking structures 1101. Moreover, some of the plural top-side docking structures 1101 that are formed on the top side 100a in a U-shaped arrangement and located near the lateral sides 100c, 100d, 100e and 100f (i.e., installed on the so-called back connector panel) are provided with respective first electrical contact structures 131. Moreover, some of the top-side docking structures 1101 comprise respective first openings 120a. The plural bottom-side docking structures 1102 are located at the bottom side 100b. Moreover, some of the plural bottom-side docking structures 1102 are provided with respective second electrical contact structures 132. The plural second openings 120b are formed in the corresponding bottom-side docking structures 1102. Preferably, each second opening 120b is aligned with one of the plural first openings 120a. Consequently, the power-storage building block 100 and an adjacent electrical building block 100 with the similar or identical structure can be assembled with each other, which will be described later. The plural third openings 120c are located at the lateral sides 100d, 100e and 100f.

Please refer to FIGS. 1A to 1D again. The first electrical contact structures 131 and the second electrical contact structures 132 are electrically connected with the circuit board 170 and disposed within the power-storage building block 100. In this embodiment, the plural first electrical contact structures 131 include elastic electrical connectors (e.g., A, B, C and D as shown in FIG. 1A) or pogo pins, and the plural second electrical contact structures 132 include electrical contacts or metallic pads. The first electrical contact structures 131 are penetrated through the corresponding first openings 120a in the top side 100a and the corresponding third openings 120c in the lateral sides 100d, 100e and 100f. In addition, the first electrical contact structures 131 are elastically protruded out of the corresponding top-side docking structures 1101 and the surfaces of the lateral sides 100d, 100e and 100f. The second electrical contact structures 132 are disposed within and exposed to the second openings 120b of the corresponding bottom-side docking structures 1102 and the corresponding third openings 120c in the lateral sides 100d, 100e and 100f.

Moreover, the first ends of the first electrical contact structures 131 at the top side 100a are connected with the electrical connection board 135 and electrically connected with the circuit board 170 through the electrical connection board 135. The second ends of the first electrical contact structures 131 at the top side 100a are penetrated through the corresponding first openings 120a and partially protruded out of the top-side docking structures 1101. The second electrical contact structures 132 at the bottom side 100b are electrically connected with the circuit board 170 directly and exposed to the corresponding second openings 120b.

In an embodiment, the top-side docking structures 1101 are protrusion posts, and the bottom-side docking structures 1102 are concave structures. The top-side docking structures 1101 are in an array arrangement and/or the bottom-side docking structures 1102 are in an array arrangement so as to be docked with the general LEGO building blocks.

When the top side 100a of the power-storage building block 100 and the bottom side 100b of an adjacent power-storage building block 100 with the similar or identical structure are assembled with each other, the first electrical contact structures 131 that are aligned with the corresponding first openings 120a and elastically protruded out of the corresponding top-side docking structures 1101 are elastically contacted with the second electrical contact structures 132 that are exposed to the second openings 120b of the corresponding bottom-side docking structures 1102 of the adjacent power-storage building block 100. Consequently, the first electrical contact structures 131 of this power-storage building block 100 and the corresponding second electrical contact structures 132 of the adjacent power-storage building block 100 are electrically with each other to transfer signals such as power signals (e.g., electric power) or electrical signals (e.g., control signals).

Moreover, the first lateral side 100c, the second lateral side 100d, the third lateral side 100e and the fourth lateral side 100f are arranged between the top side 100a and the bottom side 100b of the power-storage building block 100. The first lateral side 100c includes the switch element 140 and the indication lamp 150. Each of the second lateral side 100d and the third lateral side 100e includes the first electrical contact structures 131 and the second electrical contact structures 132. The fourth lateral side 100f includes the first electrical contact structures 131, the second electrical contact structures 132 and the connecting port 160.

Please refer to FIGS. 1C and 1D. In a preferred embodiment, the top side 100a, the top-side docking structures 1101, the first lateral side 100c, the second lateral side 100d, the third lateral side 100e and the fourth lateral side 100f are integrally formed as a one-piece structure. Moreover, this one-piece structure and the bottom side 100b with the bottom-side docking structures 1102 are collaboratively defined as a block body. The upper edges of the lateral sides 100d, 100e and 100f are connected with the periphery of the top side 100a. Moreover, the lower edges of the lateral sides 100d, 100e and 100f are connected with the periphery of the bottom side 100b.

The power-storage building block 100 is selectively turned on or turned off through the switch element 140. The indication lamp 150 is used for identifying or warning the operating status of the power-storage building block 100. For example, when the power-storage building block 100 is in the on state to discharge electricity, the indication lamp 150 emits a green light beam. Moreover, when the power-storage building block 100 is in an abnormal condition (e.g., a short-circuited condition), the indication lamp 150 emits a red light beam. Moreover, when the power-storage building block 100 is a charging state, the indication lamp 150 emits a yellow light beam. For example, the connecting port 160 is a universal serial bus (USB) interface. In case that the power-storage building block 100 is charged through a wireless charging technology, the connecting port 160 may be optionally omitted. Under this circumstance, the user can realize whether the power-storage building block 100 is in a wireless charging state through the indication lamp 150.

Moreover, the two electrical contact structures 131 and 132 with different docking specifications are located at each of the lateral sides 100d, 100e and 100f. Consequently any two power-storage building blocks 100 can be arbitrarily docked with each other and electrically connected with each other through the electrical contact structures 131 and 132 corresponding to the lateral side 100d, 100e or 100f without being limited by the assembling direction. That is, the power-storage building block 100 can be assembled with the adjacent power-storage building block 100 through the electrical contact structures 131 and 132 corresponding to the lateral side 100d, 100e or 100f. That is, the connection between two adjacent power-storage building blocks is not restricted to the unidirectional connection. Moreover, the docking relationship between adjacent power-storage building blocks is not restricted to the one-to-one relationship.

In some embodiments, the arrangements of the electrical contact structures 131 and 132 with different docking specifications and at the lateral side 100d, 100e or 100f are specially designed. For example, the electrical contact structures complying with a first docking specification are horizontally arranged side by side, and the electrical contact structures complying with a second docking specification are horizontally arranged side by side. Moreover, the electrical contact structures with the second docking specification are horizontally located beside the electrical contact structures with the first docking specification. Take the power-storage building block as shown in FIGS. 1A to 1E for example. In each lateral side and from right to left, two male connectors (e.g., plugs or pins) are horizontally arranged side by side and then two female connectors (e.g. receptacles or pads) are horizontally arranged side by side. The arrangements of the electrical contact structures as shown in FIGS. 1A to 1E can enhance the flexibility and convenience of assembling plural electrical building blocks. It is noted that the arrangements of the electrical contact structures are not restricted and may be altered according to the practical requirements.

Preferably, the arrangement of the electrical contact structures 131 and 132 corresponding to the lateral side 100d, the arrangement of the electrical contact structures 131 and 132 corresponding to the lateral side 100e and the arrangement of the electrical contact structures 131 and 132 corresponding to the lateral side 100f are identical. Consequently, the compatibility of laterally assembling different electrical building blocks will be enhanced.

Optionally, each of the lateral sides 100d, 100e and 100f is equipped with a magnet or a magnetic buckle (not shown). Due to the magnet or the magnetic buckle, the adjacent power-storage building blocks 10 are magnetically attracted by each other. Consequently, when any two power-storage building blocks 10 are electrically connected with each other through the electrical contact structures 131 and 132 corresponding to the lateral side 100d, 100e or 100f, the docking stability is enhanced.

It is noted that the polarities of the first electrical contact structures 131 and the second electrical contact structures 132 of the power-storage building block 100 are not restricted.

Please also refer to the arrangement of the top-side docking structures 1101 as shown in FIGS. 1A and 1E. The first electrical contact structures 131 corresponding to the top side 100a are arranged in a U-shaped arrangement and disposed in the corresponding top-side docking structures 1101. Moreover, every four first electrical contact structures 131 are located near each of the lateral sides 100d, 100e and 100f. For example, as shown in FIG. 1A, four elastic electrical connectors A, B, C and D are disposed on the top side 100a and located near the fourth lateral side 100f. The polarities of the circuitry are specially designed. In this embodiment, the polarities of the four elastic electrical connectors A, B, C and D that are horizontally arranged side by side are the negative polarity (−), the positive polarity (+), the positive polarity (+) and the negative polarity (−), which denote the ground voltage (COM), the output voltage (Vout), the output voltage (Vout) and the ground voltage (COM), respectively. Similarly, as shown in FIG. 1A, four elastic electrical connectors D, E, F and G are disposed on the top side 100a and located near the third lateral side 100e. The polarities of the four elastic electrical connectors D, E, F and G denote the ground voltage (COM), the output voltage (Vout), the output voltage (Vout) and the ground voltage (COM), respectively.

For example, the polarity of the elastic electrical connector B is the output voltage Vout. The polarities of the elastic electrical connectors A and C beside the elastic electrical connector B along the vertical direction are the ground voltage (COM) and the output voltage (Vout), respectively. Moreover, the polarity of the elastic electrical connector D is the ground voltage (COM). The polarity of the elastic electrical connector C beside the elastic electrical connector D in the horizontal direction is the output voltage Vout, and the polarity of the elastic electrical connector E beside the elastic electrical connector D along the vertical direction is also the output voltage Vout.

Similarly, the polarities of the electrical contact structures 131 and 132 on each of lateral sides 100d, 100e and 100f are the ground voltage (COM), the output voltage (Vout), the output voltage (Vout) and the ground voltage (COM) sequentially. The arrangements of the polarities are helpful for the circuitry design of the circuit board 170. In this embodiment, four elastic electrical connectors H, I, J and K are disposed on the top side 100a and located near the fourth lateral side 100f along the horizontal direction. The polarities of the four elastic electrical connectors H, I, J and K (i.e., two electrical contact structures complying with the first docking specification and two electrical contact structures complying with the second docking specification) denote the ground voltage (COM), the output voltage (Vout), the output voltage (Vout) and the ground voltage (COM), respectively. That is, the sequence of the polarities of the four elastic electrical connectors H, I, J and K is identical to the sequence of the polarities of the four elastic electrical connectors A, B, C and D along the horizontal direction.

As shown in FIGS. 1A and 1E, the sequences of the polarities of the first electrical contact structures 131 and/or the second electrical contact structures 132 corresponding to the top side 100a, the bottom side 100b, the second lateral side 100d, the third lateral side 100e and the fourth lateral side 100f of the power-storage building block 100 are identical. Moreover, the first electrical contact structures 131 and/or the second electrical contact structures 132 corresponding to the polarities of the output voltage (Vout) are serially connected with each other to define a first electric loop, and the first electrical contact structures 131 and/or the second electrical contact structures 132 corresponding to the polarities of the ground voltage (COM) are serially connected with each other to define a second electric loop.

It is noted that the design or the arrangement of the polarities of the electrical contact structures is not restricted. As for the first electrical contact structures 131 corresponding to the top side 100a, the second electrical contact structures 132 corresponding to the bottom side 100b or the electrical contact structures 131 and 132 corresponding to each of the lateral sides 100d, 100e and 100f, the arrangement of the four consecutive electrical contact structures along the horizontal direction (or the vertical direction) may be varied according to the circuitry design. For example, in another embodiment, the polarities are sequentially positive (+), negative (−), positive (+) and negative (−), or the polarities are sequentially negative (−), positive (+), negative (−) and positive (+), or the polarities are sequentially positive (+), negative (−), negative (−) and positive (+).

According to the arrangement of the four consecutive electrical contact structures along the horizontal direction (or the vertical direction), the sequence of the positive polarity (+), the positive polarity (+), the negative polarity (−) and the negative polarity (−) and the sequence of the negative polarity (−), the negative polarity (−), the positive polarity (+) and the positive polarity (+) are excluded or not included.

In an embodiment, the power-storage building block 100 comprises a built-in 3.7V lithium battery power-storage module (not shown), which is one kind of a power module. Moreover, the power-storage building block 100 comprises a boost circuit (not shown). According to power conversion, the boost circuit provides the output voltage Vout of 5V. In another embodiment, the power-storage building block 100 is a battery module that provides the output voltage Vout of 5V directly.

In some other embodiments, the arrangement of the two electrical connection mechanisms is adjusted according to the type of the electrical building block and the specification size of the electrical building block. For example, according to the electrical function modules of the electrical building blocks, electrical building blocks are classified into power-type building blocks, control-type building blocks and motion-type building blocks. The power-type building block comprises a power module. The control-type building block comprises a control module. The motion-type building block comprises a motion module. For example, the power-type building block includes the above power-storage building block 100 or the power-type building block with any other appropriate battery. An example of the control-type building block includes but is not limited to a button switch building block, a tactile switch building block, a toggle switch building block, a slide switch building block, an adjustable (or variable) resistor building block, a sensor building block, a wireless transceiver building block, an editable control program building block, a polarity-switchable building block or a boost control building block. An example of the motion-type building block includes but is not limited to an illumination building block (e.g., LED), a driving building block (e.g., a motor) or a warning building block (e.g., a buzzer). These building blocks will be described later.

The structure and appearance of the editable control program building block are designed according to the concepts of the present invention. For example, the editable control program building block has the appearance of the electrical building block as shown in FIG. 1A. Moreover, a commercially available microprocessor (e.g., an Arduino microprocessor or any other appropriate microprocessor) is integrated into the editable control program building block. Consequently, the user can write a program into the editable control program building block at will through a command input port (e.g., the connecting port 160 as shown in FIG. 1A) in order to perform the software control. The polarity-switchable building block may cooperate with the editable control program building block to transform the inputted polarity into an opposite polarity. The boost control building block may cooperate with plural driving building blocks and a power-type building block. After the electric power provided by the power-type building block is converted by the boost control building block, regulated output voltages are provided to the driving building blocks.

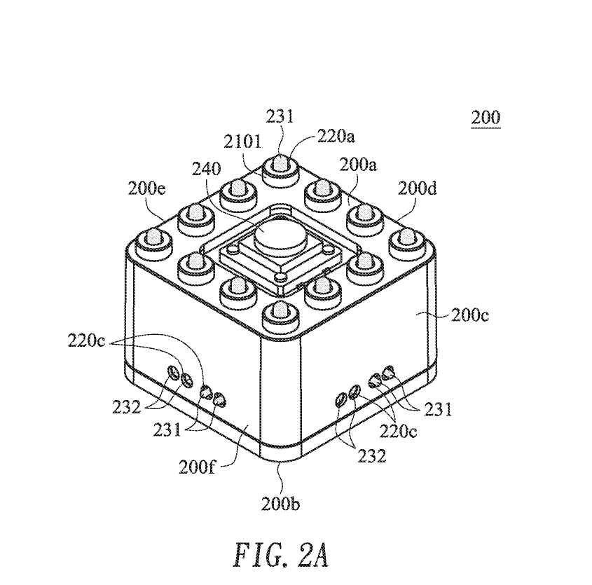

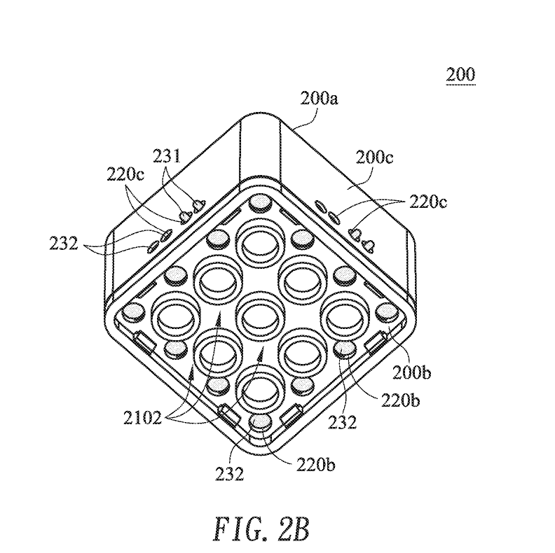

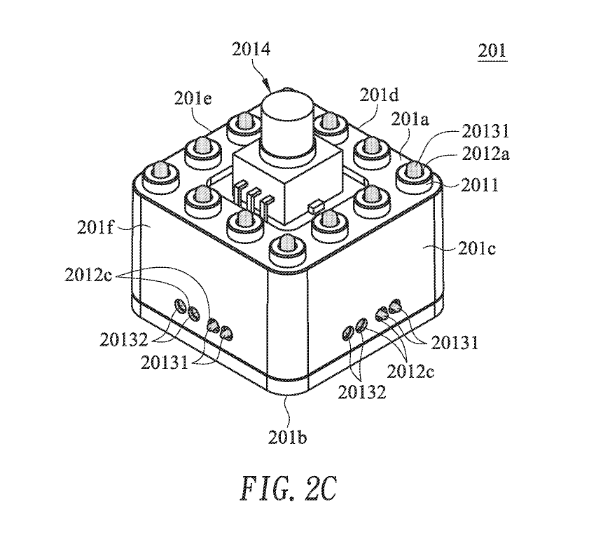

Please refer to FIGS. 2A, 2B and 2C. FIGS. 2A and 2B are schematic perspective views illustrating the concepts according to a second embodiment of the present invention and taken along different viewpoints. FIG. 2C is a schematic perspective view illustrating the concepts according to a third embodiment of the present invention.

Please refer FIGS. 2A and 2B. In this embodiment, the electrical building block 200 is a button switch building block. The button switch building block 200 comprises a top side 200a, a bottom side 200b, plural lateral sides 200c, 200d, 200e, 200f, plural top-side docking structures 2101, plural bottom-side docking structures 2102, plural first openings 220a, plural second openings 220b, plural third openings 220c, a first electrical connection mechanism with plural first electrical contact structures 231, a second electrical connection mechanism with plural second electrical contact structures 232 and an electrical function module 240 (e.g., a switch element). For example, the switch element is a button switch. For example, the electrical building block 200 is a switch building block 200 of the control-type building blocks. Of course, the switch element may have different variant examples, e.g., a tactile switch or a toggle switch.

Similarly, the plural top-side docking structures 2101 are formed on the top side 200a of the button switch building block 200, and the plural bottom-side docking structures 2102 are formed on the bottom side 200b of the button switch building block 200. In comparison with the above embodiment as shown in FIGS. 1A to 1E, the plural top-side docking structures 2101 are circumferentially formed on the top side 200a and located near the lateral sides 200c, 200d, 200e and 200f. That is, the plural top-side docking structures 2101 circumferentially formed on the top side 200a are installed on the so-called back connector panel. Each top-side docking structure 2101 comprises one first opening 220a. Moreover, some of the bottom-side docking structures 2102 have corresponding second openings 220b. The second openings 220b are formed in the surface of the bottom side 200b. Each second opening 220b is aligned with one of the plural first openings 220a. The locations of the second openings 220b correspond to the locations of the first openings 220a, respectively. That is, the second openings 220b are formed in the bottom side 200b and located near the lateral sides 200c, 200d, 200e and 200f. Consequently, the bottom-side docking structures 2102 can be assembled and positioned with the corresponding top-side docking structures 2101 of an adjacent electrical building block.

The first electrical contact structures 231, the second electrical contact structures 232 and the switch element 240 are electrically connected with the circuit board (not shown) within the electrical building block 200. Like the above embodiment, the first electrical contact structures 231 are elastic electrical connectors or pogo pins, and the second electrical contact structures 232 are electrical contacts or metallic pads.

In this embodiment, the structures of the top-side docking structures 2101 and the bottom-side docking structures 2102 of the button switch building block 200 are improved while retaining the overall basic appearance and the docking function of the original building block. The plural first openings 220a are formed in the corresponding top-side docking structures 2101. The plural second openings 220b are formed in the corresponding bottom-side docking structures 2102. Through the first openings 220a and the second openings 220b, the first electrical contact structures 231 and the second electrical contact structures 232 of two adjacent electrical building blocks are electrically with each other to transfer signals. In such way, the button switch building block 200 can be docked and assembled with any other appropriate non-electrical building block and/or any other appropriate electrical building block along a vertical direction (or an upward/downward direction). Moreover, the button switch building block 200 provides the electrical connection function to transfer signals.

Moreover, according to the designed functions of the button switch building block 200, the locations of the first electrical contact structures 231 and the second electrical contact structures 232 are correspondingly adjusted. For example, both of the first electrical contact structures 231 and the second electrical contact structures 232 are located at one or plural lateral sides of the lateral sides 200c, 200d, 200e and 200f, which have the third openings 220c. In this embodiment, both of the first electrical contact structures 231 and the second electrical contact structures 232 are located at each of the four lateral sides 200c, 200d, 200e and 200f. In such way, the button switch building block 200 can be docked and assembled with any other appropriate non-electrical building block and/or any other appropriate electrical building block along a lateral direction (or a horizontal direction). This design is helpful for electrically connecting the single electrical building block with plural adjacent building blocks. For example, the button switch building block 200 has a specification dimension of 31.8×31.8×19.9 mm, which is equivalent to the 4×4 size of the LEGO building block. Moreover, the button switch building block 200 can be assembled with the above power-storage building block 100.

The numbers of the first openings 220a, the second openings 220b, the third openings 220c, the first electrical contact structures 231 and/or the second electrical contact structures 232 may be varied according to the practical requirements.

It is noted that the design or the arrangement of the polarities of the electrical contact structures is not restricted. As for the first electrical contact structures 131 and the second electrical contact structures 132, the arrangement of the four consecutive electrical contact structures along the horizontal direction (or the vertical direction) may be varied according to the circuitry design. For example, in another embodiment, the polarities are sequentially positive (+), negative (−), positive (+) and negative (−), or the polarities are sequentially negative (−), positive (+), negative (−) and positive (+), or the polarities are sequentially positive (+), negative (−), negative (−) and positive (+).

FIG. 2C is a schematic perspective view illustrating the concepts of a third embodiment of the present invention. In this embodiment, the electrical building block 201 comprises a top side 201a, a bottom side 201b, plural lateral sides 201c, 201d, 201e, 201f, plural top-side docking structures 2011, plural bottom-side docking structures (not shown), plural first openings 2012a, plural second openings (not shown), plural third openings 2012c, a first electrical connection mechanism with plural first electrical contact structures 20131, a second electrical connection mechanism with plural second electrical contact structure 20132, and a switch element 2014.

In comparison with the above embodiment, the electrical building block 201 is an adjustable resistor building block. Moreover, the switch as shown in FIGS. 2A and 2B is replaced with an adjustable resistor switch 2014, which is also an electrical functional module. By rotating the adjustable resistor switch 2014 of the adjustable resistor building block 201, the output voltage Vout is adjustable. The adjusted output voltage Vout is helpful for adjusting and control the motion-type building block. For example, the luminance of the illumination building block or the rotating speed of the motor of the driving building block is correspondingly adjusted. Similarly, by operating the slide switch of the slide switch building block (not shown), the magnitude of the output voltage Vout is adjusted and the ambient brightness is correspondingly controlled and adjusted.

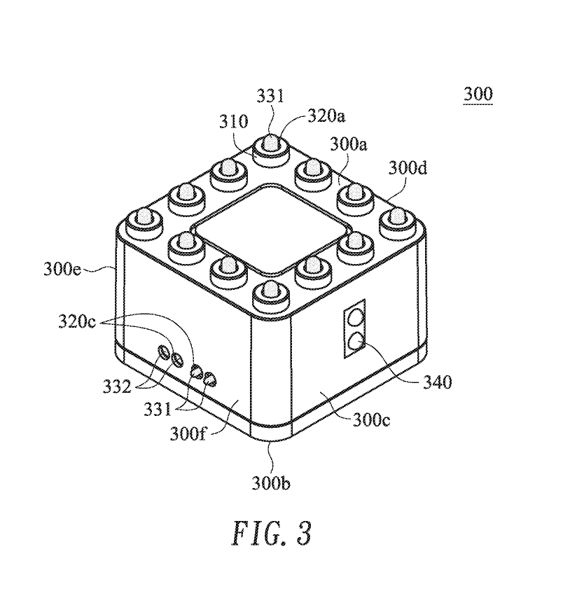

Moreover, according to the functions, the electrical building block has plural implementation examples. FIG. 3 to FIG. 5 are schematic perspective views illustrating the concepts according to a fourth embodiment, a fifth embodiment and a sixth embodiment according to the present invention.

As shown in FIG. 3, the electrical building block 300 is a sensor building block 300 of the control-type building block. The sensor building block 300 comprises a top side 300a, a bottom side 300b, plural lateral sides 300c, 300d, 300e, 300f, plural top-side docking structures 310, plural bottom-side docking structures (not shown), plural first openings 320a, plural second openings (not shown), plural third openings 320c, a first electrical connection mechanism with plural first electrical contact structures 331, a second electrical connection mechanism with plural second electrical contact structures 332 and a sensing element 340. The sensing element 340 is also an electrical function module. For example, the sensing element 340 is a reflective photoelectric sensor, a photosensor, a temperature sensor or a gas sensor (e.g., a carbon dioxide sensor) in order to provide a sensing-type electrical function.

Similarly, the plural top-side docking structures 310 are formed on the top side 300a of the sensor building block 300, and the plural bottom-side docking structures (not shown) are formed on the bottom side 300b of the sensor building block 300. Moreover, the first openings 320a and the second openings (not shown) are formed in the corresponding top-side docking structures 310 and the corresponding bottom-side docking structures. Through the first openings 320a and the second openings, the first electrical contact structures 331 and the second electrical contact structures 332 of two adjacent electrical building blocks are electrically with each other to transfer signals. In this embodiment, the first electrical contact structures 331 and the second electrical contact structures with different docking specifications are located at each of the four lateral sides 300c, 300d, 300e and 300f. This design is helpful for assembling and electrically connecting the sensor building block 300 with plural adjacent electrical building blocks along a lateral direction (or a horizontal direction). Since the assembling direction is not restricted, the flexibility of assembling electrical building blocks is enhanced.

In comparison with the above embodiments, the sensing element 340 is disposed on the lateral side 300c. Moreover, both of the first electrical connection mechanism and the second electrical connection mechanism are located at each of the lateral sides 300d, 300e and 300f. The locations of these components are not restricted and may be varied according to the practical requirements. For example, in another embodiment, the sensing element 340 is disposed on the top side 300a. Under this circumstance, both of the first electrical connection mechanism and the second electrical connection mechanism are located at each of the lateral sides 300c, 300d, 300e and 300f.

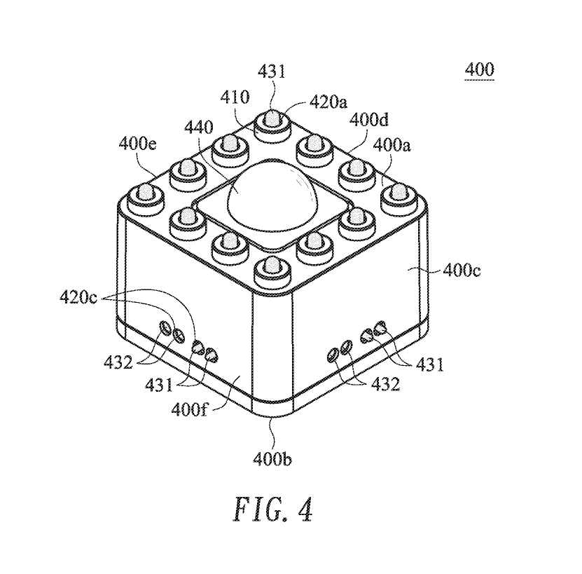

As shown in FIG. 4, the electrical building block 400 is an illumination building block 400 of the motion-type building block. The illumination building block 400 comprises a top side 400a, a bottom side 400b, plural lateral sides 400c, 400d, 400e, 400f, plural top-side docking structures 410, plural bottom-side docking structures (not shown), plural first openings 420a, plural second openings (not shown), plural third openings 420c, a first electrical connection mechanism with plural first electrical contact structures 431, a second electrical connection mechanism with plural second electrical contact structures 432 and a light-emitting element 440. The light-emitting element 440 is also an electrical function module in order to provide an illumination-type electrical function. For example, the light-emitting element 440 is a monochromatic light emitting diode (LED) or a polychromatic LED.

Similarly, through the first openings 420a and the second openings, the first electrical contact structures 431 and the second electrical contact structures 432 of two adjacent electrical building blocks are electrically with each other to transfer signals. In comparison with the above embodiments, the light-emitting element 440 is disposed on the top side 400a. Moreover, both of the first electrical connection mechanism and the second electrical connection mechanism are located at each of the lateral sides 400c, 400d, 400e and 400f. According to the function of the light-emitting element 440, the locations of the first electrical contact structures 431 and the second electrical contact structures 432 may be varied.

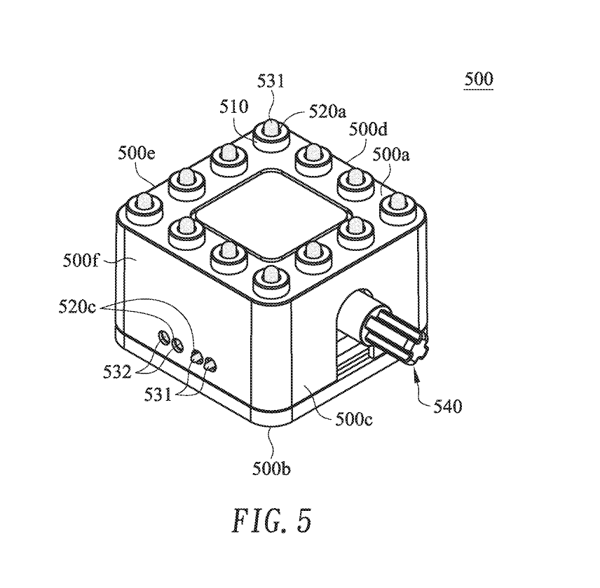

Of course, the motion-type building block may have other variant examples. As shown in FIG. 5, the electrical building block is a driving building block 500. The driving building block 500 comprises a top side 500a, a bottom side 500b, plural lateral sides 500c, 500d, 500e, 500f, plural top-side docking structures 510, plural bottom-side docking structures (not shown), plural first openings 520a, plural second openings (not shown), plural third openings 520c, a first electrical connection mechanism with plural first electrical contact structures 531, a second electrical connection mechanism with plural second electrical contact structures 532 and a driving element 540. The driving element 540 is also an electrical function module. For example, the driving element 540 is a motor, which is directly docked with an adjacent electrical building block and/or an adjacent non-electrical building block in order to drive rotation of the building block and provide the driving-type electrical function.

Similarly, through the first openings 520a, the second openings and the third openings 520c, the first electrical contact structures 531 and the second electrical contact structures 532 of two adjacent electrical building blocks are electrically with each other to transfer signals. Consequently, according to a signal from a control-type building block (e.g., the switch building block or the sensor building block as described above), the driving building block 500 is correspondingly rotated.

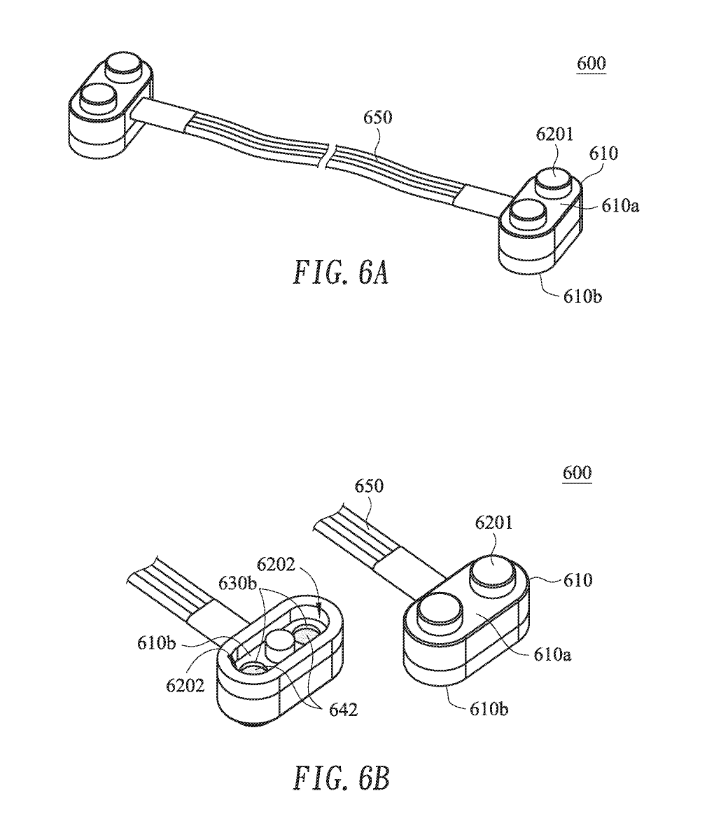

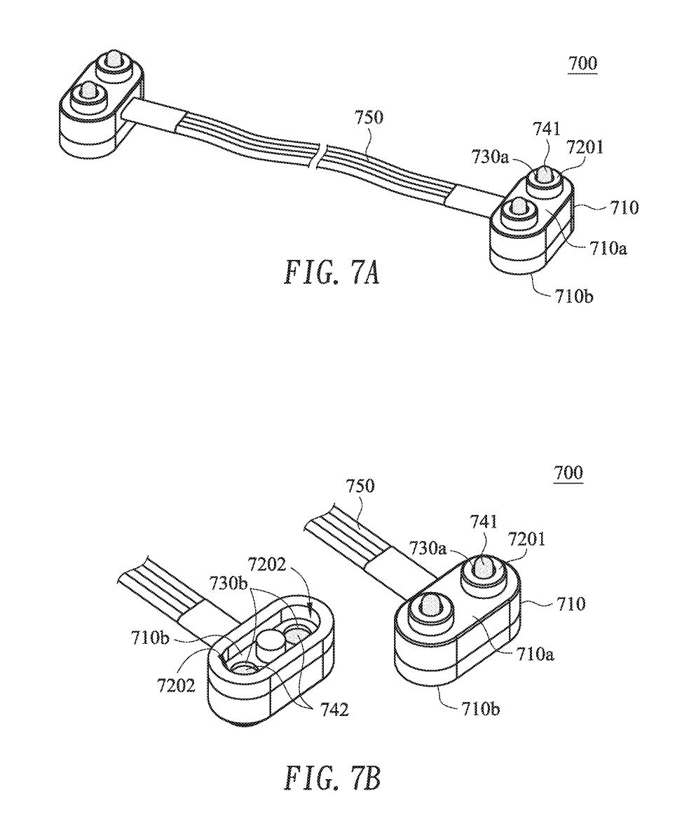

As mentioned above, the concepts of the present invention can be applied to various types of electrical building blocks. Furthermore, the concepts of the present invention can be applied to cord-type electrical building blocks. FIG. 6A to FIG. 7B are schematic perspective views and partial enlarged views of the concepts of a seventh embodiment and an eighth embodiment according to the present invention.

FIG. 6A is schematic perspective view illustrating the concepts according to a seventh embodiment of the present invention. FIG. 6B is a partial enlarged view illustrating the concepts as shown in FIG. 6A. In FIG. 6A and FIG. 6B, a cord-type electrical building block 600 is provided. In this embodiment, the cord-type electrical building block 600 complies with a single docking specification. The cord-type electrical building block 600 comprises a block body 610, a top side 610a, bottom side 610b, plural top-side docking structures 6201, plural bottom-side docking structures 6202, plural second openings 630b, a second electrical connection mechanism with plural second electrical contact structures 642 (e.g., female connectors) and an extension cord 650. The extension cord 650 is also an electrical function module. A first part and a second part of the block body 610 are located at two ends of the cord-type electrical building block 600, respectively. The first part and the second part of the block body 610 are electrically connected with each other through the extension cord 650. Moreover, the plural top-side docking structures 6201 are formed on the top sides 610a of the block bodies 610. The plural bottom-side docking structures 6202 are formed on the bottom side 610b of the block body 610 and comprise the plural second openings 630b. The second electrical contact structures 642 are disposed within the plural second openings 630b.

When the first part and the second part of the block body 610 of the cord-type electrical building block 600 are docked with any two of the electrical building blocks 100, 200, 300, 400 and 500, the first electrical contact structures 131, 231, 331, 431 and 531 corresponding to the top-side docking structures 1101, 2101, 310, 410 and 510 are elastically contacted with the second electrical contact structures 642 of the bottom-side docking structures 6202 on the bottom side 610b of the block body 610. Consequently, any two of the electrical building blocks 100, 200, 300, 400 and 500 are electrically connected with each other to transfer signals through two of the first electrical contact structures 131, 231, 331, 431 and 531 and the second electrical contact structures 642.

It is noted that numerous modifications and alterations may be made while retaining the teachings of the invention. For example, in another embodiment (not shown), the block body 610 is located at a single end of the extension cord 650.

The cord-type electrical building block has another variant example. FIG. 7A is schematic perspective view illustrating the concepts according to an eighth embodiment of the present invention. FIG. 7B is a partial enlarged view illustrating the concepts as shown in FIG. 7A. In this embodiment, the cord-type electrical building block 700 complies with two docking specifications. As shown in FIG. 7A and FIG. 7B, the cord-type electrical building block 700 comprises a block body 710, a top side 710a, a bottom side 710b, plural top-side docking structures 7201, plural bottom-side docking structures 7202, plural first openings 730a, plural second openings 730b, a first electrical connection mechanism with plural first electrical contact structures 741, a second electrical connection mechanism with plural second electrical contact structures 742 and an extension cord 750.

A first part and a second part of the block body 710 are located at two ends of the cord-type electrical building block 700, respectively. The first part and the second part of the block body 710 are electrically connected with each other through the extension cord 750. In comparison with the above embodiment, each top-side docking structure 7201 on the top surface 710a of the block body 710 comprises one first opening 730a. Each first electrical contact structure 741 (e.g., a male connector) is penetrated through one of the plural first openings 730a and elastically contacted with the second electrical contact structure (e.g., a female connector) of the adjacent electrical building block. The plural second openings 730b are formed in the bottom-side docking structures 7202 of the bottom side 710b. The second electrical contact structures 742 (e.g., female connectors) are disposed within and exposed to the second openings 730b of the corresponding bottom-side docking structures 7202. Consequently, the second electrical contact structures 742 can be electrically connected with the corresponding first electrical contact structures (e.g., a male connector) of an adjacent electrical building block (not shown).

It is noted that numerous modifications and alterations may be made while retaining the teachings of the invention. For example, in another embodiment (not shown), the block body 710 is located at a single end of the extension cord 750.

The cord-type electrical building blocks 600 and 700 are designed according to the concepts of the present invention while retaining the docking functions of the building blocks. Consequently, more electrical building blocks can be connected with each other, and the electric operation and use flexibility will be enhanced.

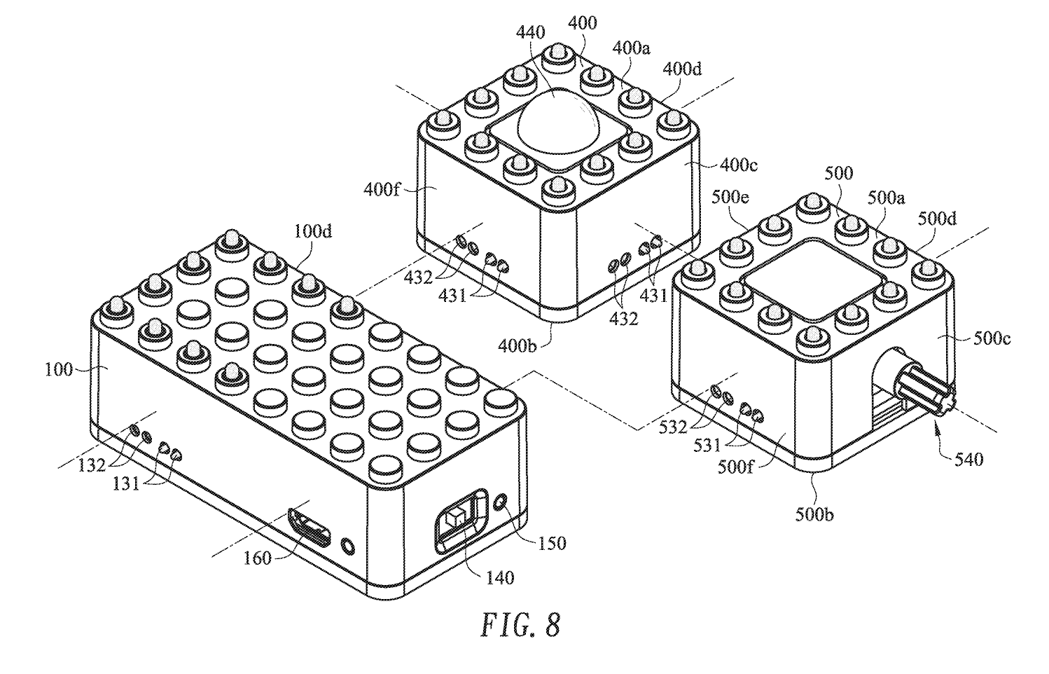

The assembling methods and the application scenarios of the above electrical building blocks will be described as follows. FIGS. 8 to 12 schematically illustrate five methods of assembling the electrical building blocks according to the concepts of the present invention.

Please refer to the above drawings and FIG. 8. In FIG. 8, the power-storage building block 100, the illumination building block 400 and the driving building block 500 are shown. The three electrical building blocks 100, 400 and 500 may be further equipped with magnetic buckles or magnets (not shown). Consequently, these electrical building blocks are magnetically attracted by each other along a lateral direction (or a horizontal direction).

Please also refer to the above drawings. The electrical contact structures 131 and 132 corresponding to the second lateral side 100d of the power-storage building block 100 are magnetically attracted by and electrically connected with the electrical contact structures 431 and 432 corresponding to the fourth lateral side 400f of the illumination building block 400. Moreover, the fourth lateral side 500f of the driving building block 500 is located beside the second lateral side 100d of the power-storage building block 100.

As mentioned above, the arrangements of the electrical contact structures with two different docking specifications and at each lateral side are specially designed. That is, the arrangements of the electrical contact structures (131, 132), (431, 432) and (531, 532) are specially designed. For example, the electrical contact structures complying with a first docking specification (e.g., the first electrical contact structures) are horizontally arranged side by side, and the electrical contact structures complying with a second docking specification (e.g., the second electrical contact structures) are horizontally arranged side by side. Moreover, the electrical contact structures with the second docking specification are located beside the electrical contact structures with the first docking specification. Please refer to FIG. 8. From right to left, two male connectors (e.g., plugs or pins) 131, 431 or 531 are horizontally arranged side by side and then two electrical contact structures complying with a different docking specification are horizontally arranged side by side located beside the two male connectors. As shown in FIG. 8, two female connectors (e.g. receptacles or pads) 132, 432 or 532 are horizontally arranged side by side and located beside the two male connectors. The arrangements of the electrical contact structures as shown in FIG. 8 can enhance the flexibility and convenience of assembling plural electrical building blocks.

Consequently, after the switch element 140 of the power-storage building block 100 is turned on, the power-storage building block 100 provides electricity to the illumination building block 400 through the electrical contact structures 131 and 132 corresponding to the second lateral side 100d. Then, the electricity is provided to the driving building block 500 through the electrical contact structures 431 and 432 corresponding to the first lateral side 400c of the illumination building block 400. Consequently, after the power-storage building block 100 is turned on, the illumination building block 400 emits a light beam and the driving building block 500 is rotated.

In other words, the electrical building block are electrically connected with adjacent electrical building blocks through the electrical contact structures corresponding to the lateral sides in order to receive signals from plural electrical building blocks or transmit signals to plural electrical building blocks.

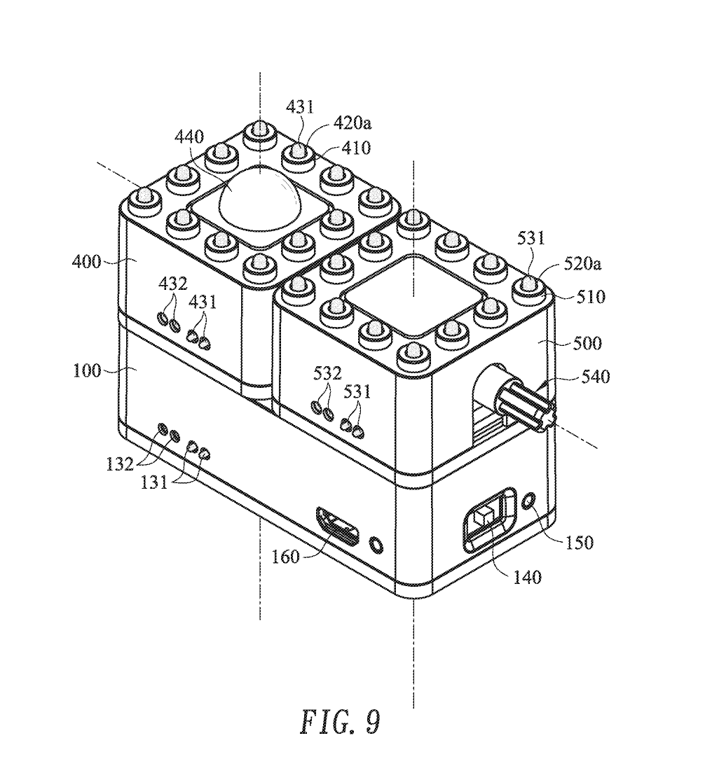

Please refer to the above drawings and FIG. 9. As shown in FIG. 9, the power-storage building block 100, the illumination building block 400 and the driving building block 500 are assembled with each other through top-side docking structures 1101, 410 and 510. The top-side docking structures 1101 of the power-storage building block 100 are assembled with and positioned in the bottom side 400b of the illumination building block 400 and the bottom side 500b of the driving building block 500. Consequently, the first electrical contact structures 131 of the docking structures 110 are elastically contacted with the second electrical contact structures 432 of the illumination building block 400 and the electrical contact structures of the driving building block 500. In such way, the three electrical building blocks are electrically connected with each other.

After the switch element 140 of the power-storage building block 100 is turned on, the power-storage building block 100 provides electricity to the illumination building block 400 and the driving building block 500. Consequently, the power-storage building block 100 can drive the illumination building block 400 to emit a light beam and drive the rotation of the driving building block 500.

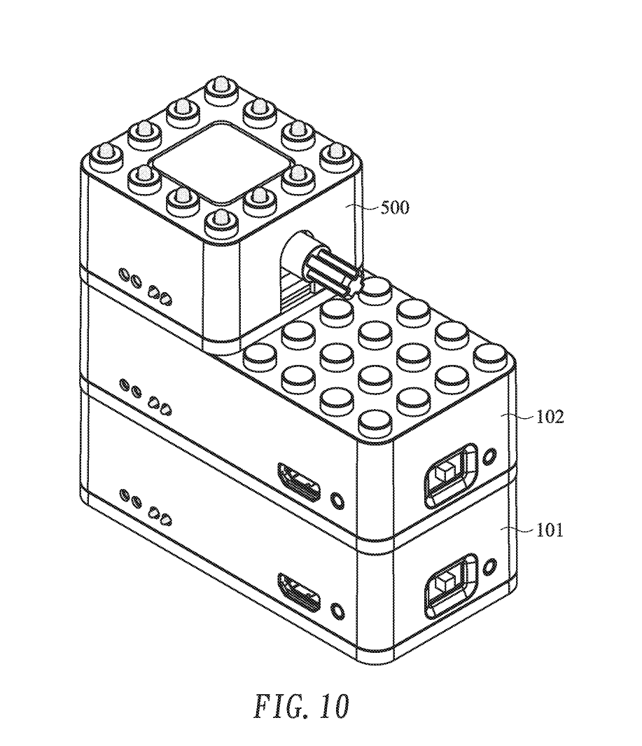

Please refer to the above drawings and FIG. 10. In FIG. 10, two power-storage building blocks 101, 102 and a driving building block 500 are shown. The two power-storage building blocks 101 and 102 are assembled with and electrically connected with each other through the corresponding docking structures. The driving building block 500 is assembled with the corresponding docking structures of the power-storage building block 102. After the first power-storage building 101 is turned on, the motor of the driving building block 500 is rotated. In case that the storage power amount is decreased or insufficient, the second power-storage building 102 is turned on. Consequently, the time period of rotating the motor of the driving building block 500 is extended. When the two power-storage building blocks 101 and 102 are assembled with and electrically connected with each other, according to the two electrical connection mechanisms and the electrical properties, the electricity amounts are balanced or the backup electricity is provided.

In some other embodiments, the second power-storage building block 102 is replaced with the above editable control program building block (not shown). Similarly, the editable control program building block has the appearance of the electrical building block as shown in FIG. 1A. Consequently, the user can write a program into the editable control program building block at will through a command input port (e.g., the connecting port 160 as shown in FIG. 1A). According to the practical requirements, the driving approach of the driving building block 500 is flexibly adjusted.

As mentioned above, the polarities of the two electrical contact structures are negative (−), positive (+), positive (+) and negative (−), respectively. Consequently, plural electrical building blocks are electrically connected with each other according to the polarities of the electrical properties.

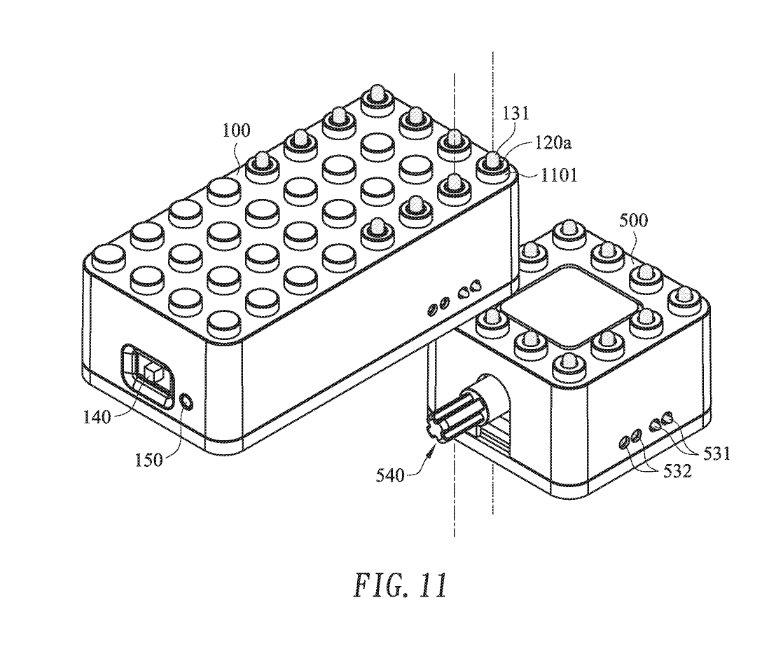

Please refer to the above drawings and FIG. 11. In FIG. 11, a power-storage building block 100 and a driving building block 500 are provided. Every two adjacent top-side docking structures 510 of the driving building block 500 are assembled with and positioned in the bottom side 100b of the power-storage building block 100. In addition, the polarities of two first electrical contact structures of the two adjacent top-side docking structures 510 are negative (−) and positive (+), and thus an electrical loop is defined. Consequently, the power-storage building block 100 provides electricity to drive the rotation of the driving building block 500. Due to the polarity design of the circuitry, a single electrical building block can provide signals to plural electrical building blocks, or a single electrical building block can be controlled by plural electrical building blocks.

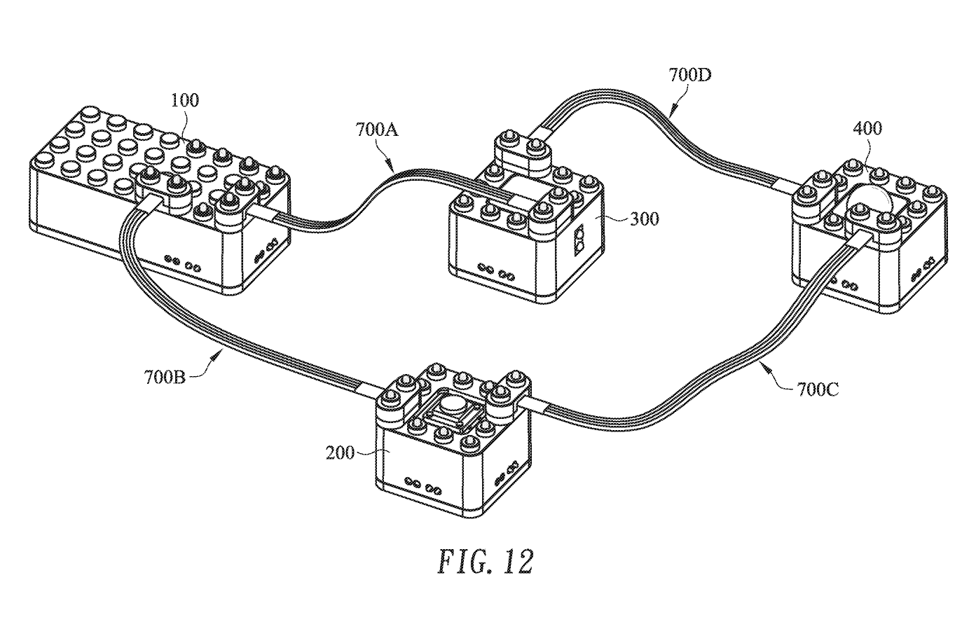

The technology of the present invention can be clearly understood from FIG. 12, which schematically illustrates a fifth method of assembling the electrical building blocks according to the concepts of the present invention.

In the above drawings and FIG. 12, a power-storage building block 100, a button switch building block 200, a sensor building block 300 and an illumination building block 400 are provided. The power-storage building block 100 is electrically connected with the button switch building block 200 and the sensor building block 300 through two cord-type electrical building blocks 700B and 700A. The button switch building block 200 and the sensor building block 300 are electrically connected with illumination building block 400 through other two cord-type electrical building blocks 700C and 700D. Consequently, the power-storage building block 100 provides electricity to the button switch building block 200 and the sensor building block 300. Moreover, according to the control conditions of the button switch building block 200 and the sensor building block 300, the illumination building block 400 is driven to emit a light beam.

For example, the switch element 240 of the button switch building block 200 is a button switch, and the sensing element 340 of the sensor building block 300 is a photosensor. When the button switch 240 is pressed down in response to an external force, the illumination building block 400 is electrically conducted to emit the light beam. In case of darkness or insufficient ambient light intensity, the photosensor is triggered to enable the illumination building block 400. Consequently, the illumination building block 400 emits the light beam.

In another scenario, the sensing element 340 of the sensor building block 300 is a gas sensor, and the light-emitting element 440 of the illumination building block 400 is a three-color LED (e.g., RGB LED). When the button switch 240 is pressed down, the illumination building block 400 is electrically conducted to emit a green light beam. When the gas sensor detects that the carbon dioxide concentration in the environment exceed a preset value, the illumination building block 400 is driven to emit a red light beam to prompt the user.

In other words, the proper type of electrical building block of the present invention can be assembled with the general building block according to the practical scene or the teaching requirement. Moreover, plural electrical building blocks can be assembled with and electrically connected with each other according to the designs of the first electrical connection mechanism, the second electrical connection mechanism, the first openings and the second openings. Consequently, the overall use convenience, creativity and interesting efficacy are enhanced

It is noted that numerous modifications and alterations may be made while retaining the teachings of the invention. The structures and specifications of the above components may be varied according to the practical requirements. As long as the functions of the present invention are achieved, the structures are not restricted.

From the above descriptions, the present invention provides the electrical building block. The electrical building block retains the docking functions to be assembled with the general building blocks. In addition, the top-side docking structures and the bottom-side docking structures of the building blocks are improved. The two electrical connection mechanisms are located at the top-side docking structures and the bottom-side docking structures. Consequently, the first electrical contact structures are penetrated through the top surface of the electrical building block and elastically contacted and electrically connected with the second electrical contact structures at the bottom side of the adjacent electrical building block. Moreover, the two electrical connection mechanisms complying with different docking specifications are formed on at least one lateral side of the electrical building block. Consequently, plural electrical building blocks can be electrically connected with each other in diverse directions.

Moreover, the polarities of the electrical contact structures of the two electrical connection mechanisms are specially designed. The electrodes with the same polarity are connected with the same electric node of the circuitry of the circuit board. The arrangement of the polarities of the two electrical connection mechanisms at any lateral side of the electrical building block is also specially designed. Consequently, plural electrical building blocks are electrically connected with each other without being limited by the docking structures, polarities and assembling directions of the electrical contact structures. Consequently, the electrical building block of the present invention is user-friendly, easy-to-operate and diverse. In such way, the purpose of assembling plural electrical building blocks with various specifications is achievable.

Moreover, the electrical building blocks of the present invention are equipped with electrical function modules with diverse functions. The majority of the electrical function module is accommodated within the inner space of the electrical building block, and the surface of the electrical building block retains the docking structures to be assembled with other electrical building blocks. Consequently, the aesthetically-pleasing appearance and the safety of using the electrical building block will be enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An electrical building block, comprising:
a block body comprising a top side, a bottom side, plural top-side docking structures, plural bottom-side docking structures, and plural lateral sides between the top side and the bottom side, wherein one of the top side and the bottom side is provided with a first electrical connection mechanism, the other of the top side and the bottom side is provided with a second electrical connection mechanism, and at least one of the plural lateral sides is provided with the first electrical connection mechanism and the second electrical connection mechanism; and
an electrical function module combined with the block body, wherein the electrical function module is electrically connected with at least one of the first electrical connection mechanism and the second electrical connection mechanism, and the electrical function module performs an electrical function operation.

2. The electrical building block according to claim 1, further comprising a circuit board, wherein the circuit board is electrically connected with the first electrical connection mechanism, the second electrical connection mechanism and the electrical function module.

3. The electrical building block according to claim 2, further comprising an electrical connection board, wherein a first end of at least one electrical contact structure of the first electrical connection mechanism is connected with the electrical connection board and electrically connected with the circuit board through the electrical connection board, a second end of the at least one electrical contact structure of the first electrical connection mechanism is protruded out of the top side, and at least one electrical contact structure of the second electrical connection mechanism is electrically contacted with the circuit board and exposed to the bottom side.

4. The electrical building block according to claim 1, wherein at least one electrical contact structure of the first electrical connection mechanism is disposed within at least one corresponding top-side docking structure, or at least one electrical contact structure of the second electrical connection mechanism is disposed within at least one corresponding bottom-side docking structure.

5. The electrical building block according to claim 4, wherein the at least one electrical contact structure of the first electrical connection mechanism is received within or exposed to a first opening in the at least one corresponding top-side docking structure, and the at least one electrical contact structure of the second electrical connection mechanism is exposed to or received within a second opening in the at least one corresponding bottom-side docking structure.

6. The electrical building block according to claim 1, wherein at least one electrical contact structure of the first electrical connection mechanism and at least one electrical contact structure of the second electrical connection mechanism corresponding to the at least one of the plural lateral sides are horizontally arranged side by side, and the at least one electrical contact structure of the first electrical connection mechanism and the at least one electrical contact structure of the second electrical connection mechanism are received within or exposed to plural third openings in the at least one of the plural lateral sides.

7. The electrical building block according to claim 1, wherein at least one electrical contact structure of the first electrical connection mechanism and at least one electrical contact structure of the second electrical connection mechanism are complementary to each other, wherein if the electrical contact structure of the first electrical connection mechanism is a male connector selected from a plug or a pin, the electrical contact structure of the second electrical connection mechanism is a female connectors selected from a receptacle or a pad, wherein if the electrical contact structure of the first electrical connection mechanism is the female connector, the electrical contact structure of the second electrical connection mechanism is the male connector.

8. The electrical building block according to claim 1, wherein the plural top-side docking structures are located at the top side, the plural bottom-side docking structures are located at the bottom side, and the plural top-side docking structures and plural bottom-side docking structures are complementary, wherein the plural top-side docking structures are in an array arrangement, and the plural bottom-side docking structures are in another array arrangement, wherein the top-side docking structures are protrusion posts and the bottom-side docking structures are concave structures, or the top-side docking structures are concave structures and the bottom-side docking structures are protrusion posts.

9. The electrical building block according to claim 1, wherein the top side, the plural top-side docking structures and the plural lateral side are integrally formed as a one-piece structure, and the one-piece structure and the bottom side with the bottom-side docking structures are collaboratively formed as the block body, wherein upper edges of the plural lateral sides are connected with the periphery of the top side, and lower edges of the plural lateral sides are connected with a periphery of the bottom side.

10. The electrical building block according to claim 1, wherein if a specified electrical contact structure of the first electrical connection mechanism and the second electrical connection mechanism has a first polarity, two electrical contact structures horizontally arranged at two opposite sides of the specified electrical contact structure have the first polarity and a second polarity, respectively, wherein if the specified electrical contact structure of the first electrical connection mechanism and the second electrical connection mechanism has the second polarity, the electrical contact structure horizontally arranged beside a first side of the specified electrical contact structure has the first polarity.

11. The electrical building block according to claim 10, wherein if the specified electrical contact structure of the first electrical connection mechanism and the second electrical connection mechanism has the second polarity, the electrical contact structure vertically arranged beside a first side of the specified electrical contact structure has the first polarity, wherein if the specified electrical contact structure of the first electrical connection mechanism and the second electrical connection mechanism has the second polarity, the electrical contact structure horizontally arranged beside a second side of the specified electrical contact structure has the first polarity, wherein if the first polarity is an output voltage or a positive polarity (+), the second polarity is a ground voltage or a negative polarity (−), wherein if the second polarity is the output voltage or the positive polarity (+), the second polarity is the ground voltage or the negative polarity (−).

12. The electrical building block according to claim 1, wherein if a specified electrical contact structure of the first electrical connection mechanism and the second electrical connection mechanism has a first polarity, two electrical contact structures horizontally arranged at two opposite sides of the specified electrical contact structure have a second polarity, wherein if the specified electrical contact structure of the first electrical connection mechanism and the second electrical connection mechanism has the second polarity, the two electrical contact structures horizontally arranged at the two opposite sides of the specified electrical contact structure have the first polarity, wherein if the first polarity is an output voltage or a positive polarity (+), the second polarity is a ground voltage or a negative polarity (−), wherein if the second polarity is the output voltage or the positive polarity (+), the second polarity is the ground voltage or the negative polarity (−).

13. The electrical building block according to claim 1, wherein polarities of four consecutive electrical contact structures of at least one of the first electrical connection mechanism and the second electrical connection mechanism along a horizontal direction or a vertical direction are sequentially positive (+), negative (−), negative (−) and positive (+), or sequentially negative (−), positive (+), positive (+) and negative (−), or sequentially positive (+), negative (−), positive (+) and negative (−), or sequentially negative (−), positive (+), negative (−) and positive (+).

14. The electrical building block according to claim 1, wherein electrical contact structures of the first electrical connection mechanism and/or the second electrical connection mechanism having a first polarity are serially connected with each other to define a first electric loop, and electrical contact structures of the first electrical connection mechanism and/or the second electrical connection mechanism having a second polarity are serially connected with each other to define a second electric loop.

15. The electrical building block according to claim 1, wherein the electrical function module comprises at least one of a power module, a control module and a motion module, wherein if the electrical function module is the power module, the first electrical connection mechanism, the second electrical connection mechanism and the power module are assembled as a power-type building block, wherein if the electrical function module is the control module, the first electrical connection mechanism, the second electrical connection mechanism and the control module are assembled as a control-type building block, wherein if the electrical function module is the motion module, the electrical building block with the first electrical connection mechanism, the second electrical connection mechanism and the motion module are assembled as a motion-type building block.

16. The electrical building block according to claim 15, wherein the power-type building block is a power-storage building block, and a power-storage battery module is accommodated within an inner space of the power-type building block to output electricity through one of the first electrical connection mechanism and the second electrical connection mechanism.

17. The electrical building block according to claim 15, wherein the control-type building block comprises at least one of a button switch building block, a tactile switch building block, a toggle switch building block, a slide switch building block, an adjustable (variable) resistor building block, a sensor building block, a wireless transceiver building block, an editable control program building block, a polarity-switchable building block and a boost control building block, wherein the motion-type building block comprises at least one of an illumination building block, a driving building block and a warning building block.

18. The electrical building block according to claim 1, further comprising at least one magnet or at least one magnetic buckle, which are disposed on the plural lateral sides and arranged near the first electrical connection mechanism and/or the second electrical connection mechanism to enhance docking stability.

19. An electrical building block, comprising:
a block body comprising a top side, a bottom side, plural top-side docking structures, plural bottom-side docking structures and plural lateral sides, wherein the plural top-side docking structures are located at the top side, the plural bottom-side docking structures are located at the bottom side, and the plural lateral sides are arranged between the top side and the bottom side;
a first electrical connection mechanism located at the plural lateral sides and at least one of the plural top-side docking structures;
a second electrical connection mechanism located at the plural lateral sides and at least one of the plural bottom-side docking structures; and
an electrical function module combined with the block body, wherein the electrical function module is electrically connected with at least one of the first electrical connection mechanism and the second electrical connection mechanism, and the electrical function module performs an electrical function operation.

20. The electrical building block according to claim 19, further comprising a circuit board, wherein the circuit board is electrically connected with the first electrical connection mechanism, the second electrical connection mechanism and the electrical function module.

21. The electrical building block according to claim 20, further comprising an electrical connection board, wherein a first end of at least one electrical contact structure of the first electrical connection mechanism is connected with the electrical connection board and electrically connected with the circuit board through the electrical connection board, a second end of the at least one electrical contact structure of the first electrical connection mechanism is protruded out of the top side, and at least one electrical contact structure of the second electrical connection mechanism is electrically contacted with the circuit board and exposed to the bottom side.

22. The electrical building block according to claim 19, wherein at least one electrical contact structure of the first electrical connection mechanism is received within or exposed to a first opening in the at least one corresponding top-side docking structure, and at least one electrical contact structure of the second electrical connection mechanism is exposed to or received within a second opening in the at least one corresponding bottom-side docking structure.

23. The electrical building block according to claim 19, wherein at least one electrical contact structure of the first electrical connection mechanism and at least one electrical contact structure of the second electrical connection mechanism corresponding to the at least one of the plural lateral sides are horizontally arranged side by side, and the at least one electrical contact structure of the first electrical connection mechanism and the at least one electrical contact structure of the second electrical connection mechanism are received within or exposed to plural third openings in the at least one of the plural lateral sides.

24. The electrical building block according to claim 19, wherein at least one electrical contact structure of the first electrical connection mechanism and at least one electrical contact structure of the second electrical connection mechanism are complementary to each other, wherein if the electrical contact structure of the first electrical connection mechanism is a male connector selected from a plug or a pin, the electrical contact structure of the second electrical connection mechanism is a female connectors selected from a receptacle or a pad, wherein if the electrical contact structure of the first electrical connection mechanism is the female connector, the electrical contact structure of the second electrical connection mechanism is the male connector.

25. The electrical building block according to claim 19, wherein electrical contact structures of the first electrical connection mechanism and/or the second electrical connection mechanism having a first polarity are serially connected with each other to define a first electric loop, and electrical contact structures of the first electrical connection mechanism and/or the second electrical connection mechanism having a second polarity are serially connected with each other to define a second electric loop.

26. The electrical building block according to claim 25, wherein if the first polarity is an output voltage or a positive polarity (+), the second polarity is a ground voltage or a negative polarity (−), wherein if the second polarity is the output voltage or the positive polarity (+), the second polarity is the ground voltage or the negative polarity (−).

27. An electrical building block, comprising:
a block body comprising plural top-side docking structures, and/or plural bottom-side docking structures, and plural lateral sides, wherein the plural top-side docking structures are located at a top side of the block body, the plural bottom-side docking structures are located at a bottom side of the block body, and the plural lateral sides are arranged between the top side and the bottom side;
an electrical function module combined with the block body; and
plural electrical contact structures located at the plural lateral sides, at least one of the plural top-side docking structures and/or at least one of the plural bottom-side docking structures,
wherein if a specified electrical contact structure of the plural electrical contact structures has a first polarity, the two electrical contact structures horizontally arranged at two opposite sides of the specified electrical contact structure have the first polarity and a second polarity, respectively, and if the specified electrical contact structure has the second polarity, the electrical contact structure horizontally arranged beside a first side of the specified electrical contact structure has the first polarity, or
wherein if the specified electrical contact structure of the plural electrical contact structures has the first polarity, the two electrical contact structures horizontally arranged at two opposite sides of the specified electrical contact structure have the second polarity, and if the specified electrical contact structure has the second polarity, the two electrical contact structures horizontally arranged at the two opposite sides of the specified electrical contact structure have the first polarity.

28. The electrical building block according to claim 27, further comprising a circuit board, wherein the circuit board is electrically connected with the plural electrical contact structure and the electrical function module.

29. The electrical building block according to claim 27, wherein if the specified electrical contact structure has the second polarity, the electrical contact structure vertically arranged beside a first side of the specified electrical contact structure has the first polarity, or wherein if the specified electrical contact structure has the second polarity, the electrical contact structure horizontally arranged beside a second side of the specified electrical contact structure has the first polarity.

30. The electrical building block according to claim 27, wherein the electrical contact structures having a first polarity are serially connected with each other to define a first electric loop, and the electrical contact structures having a second polarity are serially connected with each other to define a second electric loop.

31. The electrical building block according to claim 27, wherein if the first polarity is an output voltage or a positive polarity (+), the second polarity is a ground voltage or a negative polarity (−), wherein if the second polarity is the output voltage or the positive polarity (+), the second polarity is the ground voltage or the negative polarity (−).

32. The electrical building block according to claim 27, wherein the plural electrical contact structures include at least one first electrical contact structure and at least one second electrical contact structure, which are complementary to each other, wherein if the first electrical contact structure is a male connector selected from a plug or a pin, the second electrical contact structure is a female connectors selected from a receptacle or a pad, wherein if the first electrical contact structure is the female connector, the second electrical contact structure is the male connector.

33. The electrical building block according to claim 32, wherein the at least one electrical contact structure is received within or exposed to a first opening in the at least one corresponding top-side docking structure, and the at least one second electrical contact structure is exposed to or received within a second opening in the at least one corresponding bottom-side docking structure.

34. The electrical building block according to claim 32, wherein the at least one first electrical contact structure and the at least one second electrical contact structure corresponding to the at least one of the plural lateral sides are horizontally arranged side by side, and the at least one first electrical contact structure and the at least one second electrical contact structure are received within or exposed to plural third openings in the at least one of the plural lateral sides.

35. The electrical building block according to claim 27, wherein the electrical function module is an extension cord, the block body is located at an end or two ends of the extension cord, and the electrical building block with the extension cord is a cord-type electrical building block, wherein the electrical contact structures of the cord-type electrical building block comply with a single docking specification, or the electrical contact structures of the cord-type electrical building block comply with two different docking specifications.

36. An electrical building block, comprising:
a block body comprising plural top-side docking structures, and/or plural bottom-side docking structures, and plural lateral sides, wherein the plural top-side docking structures are located at a top side of the block body, the plural bottom-side docking structures are located at a bottom side of the block body, and the plural lateral sides are arranged between the top side and the bottom side;
plural electrical contact structures located at the plural lateral sides, at least one of the plural top-side docking structures and/or at least one of the plural bottom-side docking structures, wherein polarities of every four consecutive electrical contact structures of the plural electrical contact structures along a horizontal direction or a vertical direction are sequentially positive (+), negative (−), negative (−) and positive (+), or sequentially negative (−), positive (+), positive (+) and negative (−), or sequentially positive (+), negative (−), positive (+) and negative (−), or sequentially negative (−), positive (+), negative (−) and positive (+); and
an electrical function module combined with the block body.

37. The electrical building block according to claim 36, further comprising a circuit board, wherein the circuit board is electrically connected with the plural electrical contact structure and the electrical function module.

38. The electrical building block according to claim 36, wherein the electrical contact structures having a first polarity are serially connected with each other to define a first electric loop, and the electrical contact structures having a second polarity are serially connected with each other to define a second electric loop.

39. The electrical building block according to claim 36, wherein the plural electrical contact structures include at least one first electrical contact structure and at least one second electrical contact structure, which are complementary to each other, wherein if the first electrical contact structure is a male connector selected from a plug or a pin, the second electrical contact structure is a female connectors selected from a receptacle or a pad, wherein if the first electrical contact structure is the female connector, the second electrical contact structure is the male connector.

40. The electrical building block according to claim 39, wherein the at least one electrical contact structure is received within or exposed to a first opening in the at least one corresponding top-side docking structure, and the at least one second electrical contact structure is exposed to or received within a second opening in the at least one corresponding bottom-side docking structure.

41. The electrical building block according to claim 39, wherein the at least one first electrical contact structure and the at least one second electrical contact structure corresponding to the at least one of the plural lateral sides are horizontally arranged side by side, and the at least one first electrical contact structure and the at least one second electrical contact structure are received within or exposed to plural third openings in the at least one of the plural lateral sides.
